(19) United States
(12) Patent Application Publication
(10) Pub. No.: US 2019/0074968 A1
(43) Pub. Date: Mar. 7, 2019

(54) METHOD, APPARATUS AND SYSTEM FOR DATA ENCRYPTION AND DECRYPTION

(71) Applicant: Alibaba Group Holding Limited, Georgetwon (KY)

(72) Inventors: Wenqing LIU, Beijing (CN); Juntao PENG, Beijing (CN)

(21) Appl. No.: 16/123,999

(22) Filed: Sep. 6, 2018

(30) Foreign Application Priority Data
Sep. 6, 2017 (CN) 201710800850.3

(51) Int. Cl. H04L 9/14; H04L 9/08; H04L 29/06; H04L 9/32; H04L 9/06

(52) U.S. Cl. CPC H04L 9/14; H04L 9/0861; H04L 63/0435; H04L 9/3247; H04L 2463/062; H04L 9/0825; H04L 9/0637; H04L 2209/38; H04L 2209/24; H04L 9/3263

(57) ABSTRACT

Method, apparatus and system for data encryption and decryption. In an embodiment, the method comprises: generating a block key and encrypting to-be-uploaded data based on the block key to obtain encrypted data; encrypting the block key based on a public key of a preset target object to obtain an encrypted block key corresponding to the preset target object; generating upload data based on the encrypted data and the encrypted block key, and uploading the upload data to a blockchain. The present invention solves the technical problems of excessive workload and complicated operation caused by implementing data access permission control in the blockchain

### PRIORITY CLAIM REFERENCE TO RELATED APPLICATION

This application claims priority to China Patent Application No. 201710800850.3 filed Sep. 6, 2017 which is incorporated herein by reference in its entirety.

### TECHNICAL FIELD

The present application relates to the field of Internet technology application, and specifically, to a method, an apparatus, and a system for data encryption and decryption.

### BACKGROUND

With the circulation of online virtual currencies such as Bitcoin, a blockchain is used as an underlying technology and infrastructure therefor to ensure the normal circulation, and the blockchain is a series of data blocks generated by using cryptographic methods. Each data block contains information of one bitcoin online transaction, which is used to authenticate validity of the information (anti-counterfeiting) and generate a next block. In a narrow sense, a blockchain is a distributed ledger that combines blocks of data in chronological order in a sequentially connected manner into a chained data structure, and is cryptographically guaranteed to be tamper-resistant and unforgeable. Therefore, for an online transaction of virtual currency or data security transmission, the existing blockchain technology enhances security of users' Internet activities through distributed data storage, point-to-point transmission, consensus mechanisms, and encryption algorithms, thereby providing reliable protection for users' data and information security.

Especially in some specific applications of the blockchain such as a blockchain credit system, blockchain public benefit or a blockchain smart contract, an application party hopes that the transaction data is kept confidential and that only specific application parties and supervision mechanisms are allowed to view transaction data. In situations like this, data access needs to be controlled.

The existing technology for controlling access to data, read permission of transaction data is controlled. This solution requires implementing a complicated data access permission control system on all data access nodes on the chain.

There is yet to be an effective solution to solve the problems of excessive workload and complicated operation caused by implementing data access permission control in the blockchain.

### SUMMARY

Embodiments of the present invention provide a method, an apparatus, and a system for data encryption and decryption, so as to at least solve a technical problem of excessive workload and complicated operation caused by implementing data access permission control in the blockchain.

According to an aspect of embodiments of the present invention, a data encryption and decryption system is provided, including: an encryption terminal, configured to generate a block key, and encrypt to-be-uploaded data with the block key to obtain encrypted data; encrypt the block key based on a public key of a preset target object to obtain an encrypted block key corresponding to the preset target object; signing the encrypted data and the encrypted block key with a private key of the encryption terminal to generate a data signature; and upload the encrypted data, the encrypted block key, and the data signature to the storage device; a storage device, configured to store the encrypted data, the encrypted block key, and the data signature; and a decryption terminal, connected to the storage device and configured to obtain the encrypted data, the encrypted block key, and the data signature; decrypt the encrypted block key with the private key of the decryption terminal to obtain the block key; and decrypt the encrypted data with the block key to obtain the to-be-uploaded data.

According to another aspect of embodiments of the present invention, a data encryption method is further provided, including: generating a block key and encrypting to-be-uploaded data based on the block key to obtain encrypted data; encrypting the block key based on a public key of a preset target object to obtain an encrypted block key corresponding to the preset target object; and generating upload data based on the encrypted data and the encrypted block key and uploading the upload data to a blockchain.

According to another aspect of embodiments of the present invention, a data decryption method is further provided, including: obtaining upload data uploaded by an encryption terminal to a blockchain; decrypting an encrypted block key in the upload data with a pre-stored private key of a decryption terminal to obtain a block key generated by the encryption terminal; and decrypting encrypted data in the upload data with the block key to obtain to-be-uploaded data encrypted by the encryption terminal.

According to another aspect of embodiments of the present invention, a data encryption apparatus is further provided, including: a first encryption module, configured to generate a block key and encrypt to-be-uploaded data based on the block key to obtain encrypted data; a second encryption module, configured to encrypt the block key based on a public key of a preset target object to obtain an encrypted block key corresponding to the preset target object; and a data uploading module, configured to generate upload data based on the encrypted data and the encrypted block key and upload the upload data to a blockchain.

According to another aspect of embodiments of the present invention, a data decryption apparatus is further provided, including: a first obtaining module, configured to obtain upload data uploaded by an encryption terminal to a blockchain; a first decryption module, configured to decrypt an encrypted block key in the upload data with a pre-stored private key of a decryption terminal to obtain a block key generated by the encryption terminal; and a second decryption module, configured to decrypt encrypted data in the upload data with the block key to obtain to-be-uploaded data encrypted by the encryption terminal.

According to another aspect of embodiments of the present invention, a storage medium is further provided. The storage medium includes: a stored program, and when the program is running, a device where the storage medium is located is controlled to execute the data encryption method.

According to another aspect of embodiments of the present invention, a storage medium is further provided. The storage medium includes: a stored program, and when the program is running, a device where the storage medium is located is controlled to execute the data decryption method.

According to another aspect of embodiments of the present invention, a processor is further provided. The processor is configured to run a program, and the program executes the data encryption method when running.

According to another aspect of embodiments of the present invention, a processor is further provided. The processor is configured to run a program, and the program executes the data decryption method when running.

According to another aspect of embodiments of the present invention, a data processing method is further provided, including: obtaining encrypted data, where keys used for generating the encrypted data include a block key; obtaining encrypted block key, where keys for encrypting the block key include a first public key; obtaining signature data, wherein keys used for signing include a second private key; and sending the encrypted data, the encrypted block key, and the signature data to a server.

According to another aspect of embodiments of the present invention, a data processing method is further provided, including: obtaining encrypted data, an encrypted block key, and signature data from a client; authenticating the signature data with a second public key; decrypting the encrypted block key with a first private key to obtain a block key; and decrypting the encrypted data with the block key to obtain upload data.

In embodiments of the present invention, encrypted data is obtained by generating a block key and encrypting to-be-uploaded data based on the block key; the block key is encrypted based on a public key of a preset target object to obtain an encrypted block key corresponding to the preset target object; and upload data is generated based on the encrypted data and the encrypted block key, and the upload data is uploaded to a blockchain, thereby achieving the objective of controlling data on the blockchain to only be viewed by permitted application parties and supervision parties, so as to achieve the technical effect of protecting user data privacy and further solve the technical problem of excessive workload and complicated operation caused by implementing data access permission control in the blockchain.

### BRIEF DESCRIPTION OF THE DRAWINGS

The accompanying drawings described herein are used to provide a further understanding of the present application, and constitute a part of the present application. The illustrative embodiments of the present application and descriptions thereof are intended to explain the present application without improperly limiting the present application In the accompanying drawings:

FIG. 1 is, according to an embodiment of the present application, a schematic system diagram of a data encryption and decryption system;

FIG. 2(a) is, according to an embodiment of the present application, a schematic diagram of an optional method of uploading data by a user terminal to a blockchain;

FIG. 2(b) is, according to an embodiment of the present application, a schematic diagram of an optional method of decrypting, by an application party or a supervision party, encrypted data obtained from the blockchain;

FIG. 3(a) is, according to an embodiment of the present application, a schematic diagram of an optional process of encrypting data and uploading it to the blockchain by a user terminal;

FIG. 3(b) is, according to an embodiment of the present application, a schematic diagram of an optional process of obtaining and encrypting data from the blockchain by an application party and a supervision party allowed to view the data;

FIG. 4 is a flowchart of a data encryption method according to an embodiment of the present application;

FIG. 5 is a flowchart of an optional data encryption method according to an embodiment of the present application;

FIG. 6 is a flowchart of an optional data encryption method according to an embodiment of the present application;

FIG. 7 is a flowchart of an optional data encryption method according to an embodiment of the present application;

FIG. 8 is a flowchart of an optional data encryption method according to an embodiment of the present application;

FIG. 8(a) is a flowchart of uploading data to a blockchain with a data encryption method according to an embodiment of the present application;

FIG. 8(b) is a flowchart of encrypting data and uploading it to a blockchain with an encryption method according to an embodiment of the present application;

FIG. 9 is a flowchart of a data decryption method according to an embodiment of the present application;

FIG. 10 is a flowchart of a data decryption method according to an embodiment of the present application;

FIG. 11 is a flowchart of an optional data decryption method according to an embodiment of the present application;

FIG. 12 is a flowchart of an optional data decryption method according to an embodiment of the present application;

FIG. 12(a) is a schematic diagram of data authentication with a data decryption method according to an embodiment of the present application;

FIG. 12(b) is a schematic diagram of privacy data authentication with a data decryption method according to an embodiment of the present application;

FIG. 13 is a flowchart of a data encryption apparatus according to an embodiment of the present application;

FIG. 14 is a flowchart of a data decryption apparatus according to an embodiment of the present application; and

FIG. 15 is a hardware structural block diagram of a computer terminal according to an embodiment of the present application.

### DETAILED DESCRIPTION OF EMBODIMENTS

In order to enable a person skilled in the art to better understand the solutions of the present application, the technical solutions in the embodiments of the present application will be described clearly and completely with reference to the accompanying drawings in the embodiments of the present application. Obviously, the described embodiments are merely some but not all of embodiments of the present application. Based on the embodiments of the present application, all other embodiments obtained by a person of ordinary skill in the art without making creative efforts shall fall within the scope of the present application.

It should be noted that the terms “first”, “second”, and the like in the specification and claims of the present application and in the above drawings are used to distinguish similar objects and are not necessarily used to describe a particular sequence or order. It should be understood that such numbers may be interchanged when appropriate so that the embodiments of the present application described herein can be implemented in orders other than those illustrated or described herein. In addition, the terms “include” and “have” and any variations thereof are intended to cover non-exclusive inclusions. For example, processes, methods, systems, products, or apparatuses that include a series of steps or units are not necessarily limited to those steps or units that are clearly listed, but may include other steps or units not clearly listed or inherent to these processes, methods, products, or devices.

First, some nouns or terms used in the description of the embodiments of the present application are applicable to the following explanation:

A blockchain refers to a distributed data storage technology. Related technologies include new application modes of computer technologies such as distributed storage, point-to-point transmission, consensus mechanisms, and encryption algorithms. For example, the blockchain divides data into different blocks. Each block is linked to a previous block with specific information, and a complete set of data is presented by linking the blocks in sequence. The “block” refers to a file for storing records, which records all the value transformation activities that occurred in its creation process; the “chain” refers to storing the block in a database in a chronological order.

An application party refers to a user (an enterprise or individual) using a blockchain in applications such as data storage, transmission or financial transactions.

A supervision party refers to an institution that supervises and manages data and transactions on the blockchain according to the law.

A symmetric encryption algorithm refers to an encryption algorithm in which encryption and decryption are performed with the same key. Specifically, in the symmetric encryption algorithm, a data sender processes a plaintext (raw data) and an encryption key through an encryption algorithm, and transforms the plaintext into a complicated encryption ciphertext and sends it out. When receiving the ciphertext, a recipient decrypts the ciphertext with the key used in the encryption and an inverse algorithm of the algorithm used in the encryption, so as to restore the ciphertext into a readable plaintext.

An asymmetric encryption algorithm refers to an encryption algorithm in which encryption and decryption are performed with different keys. Specifically, in an asymmetric encryption algorithm, the data sender uses the recipient's public key to encrypt the plaintext (raw data), and the recipient uses its own private key to decrypt the plaintext.

A digital signature refers to a method for identifying digital information. A data sender uses a hash function to generate a message digest from a message text, then uses its own private key to encrypt the message digest, and sends the encrypted digest as a digital signature of the message together with the message to the recipient. When receiving the message, the recipient calculates the message digest from the received raw message first through the same hash function as the one used for sending, and then uses the sender's public key to decrypt an additional digital signature of the message. If the two digests are the same, it is confirmed that the digital signature is from the data sender.

### Embodiment 1

According to an embodiment of the present application, an embodiment of a data encryption and decryption system is provided. It should be noted that this embodiment may be applied to various blockchain application scenarios, including but not limited to payment, transfer, stocks, securities, real estate, insurance, healthcare, supply chain management, and the like.

With the development of Internet technologies, electronic transactions such as online payment, online transfer, and online shopping have become growingly popular. Traditional electronic transactions on the Internet rely on a trustworthy third-party credit mechanism to process electronic payment information, which is subject to the credibility of the third-party credit mechanism. The blockchain is based on the principle of cryptography, which enables both parties to pay directly without the participation of a third-party intermediary, which ensures the security of electronic transactions.

The blockchain is a distributed ledger that collectively maintains a reliable database in a decentralized, trust-free manner. Theoretically, a blockchain is a distributed database that can hardly be modified and does not rely on a single technology, but rather is a result of integration of a plurality of technologies. Because the blockchain consists of many nodes that together form an end-to-end network, it has no centralized device or management mechanism. Anyone can participate in the blockchain network. Each device can be used as a node, and each node is allowed to obtain a complete copy of the database. The nodes maintain the entire blockchain together based on a set of consensus mechanisms. When any node fails, the remaining nodes can still operate normally.

As can be seen from the above description that operation rules of the blockchain are transparent and all data information is public, causing each transaction to be visible to all nodes. However, in some particular applications of the blockchain, such as blockchain credit systems, blockchain public benefit, and blockchain smart contracts, an application party hopes that the transaction data is kept confidential and allows only specific application parties and supervision institutions to view the transaction data. In this case, access to the data needs to be controlled.

At present, two solutions mainly employed in the prior art for access control of data on the blockchain are as follows: the first solution is to control read permission for transaction data, and this solution requires the implementation of a complicated data read permission control system to all data access nodes on the chain; the second solution is to store the transaction data in a trusted third party off the chain, storing only the transaction data digest on the chain. However, this solution necessitates ensuring security of the trusted third party. Once the trusted third party has a security problem, the transaction data will consequently be at risk.

It can be seen that both of the above solutions have some limitations. Both solutions essentially adopt traditional security boundary control to protect data, which is not a very secure protection for transaction data. For example, regarding the first solution, once system permission for a certain node is broken, all data will be leaked; regarding the second solution, transaction data are stored offline in a trusted third party, which is similarly adopting a boundary security control method that is potentially at risk of the system permission being broken into. Hacker penetration technologies are becoming growingly powerful, while operating system vulnerabilities are inevitable; as a result, relying on such solutions can hardly ensure data security.

According to a solution of at least one embodiment in the present application, blockchain data is encrypted and key distribution is managed, so as to implement effective control of on-chain data access; i.e., a specific application party and a supervision party obtain on-chain encrypted data and decrypt the data to obtain a data plaintext; whereas the data is kept confidential from other application parties or supervision parties that are not allowed to access it.

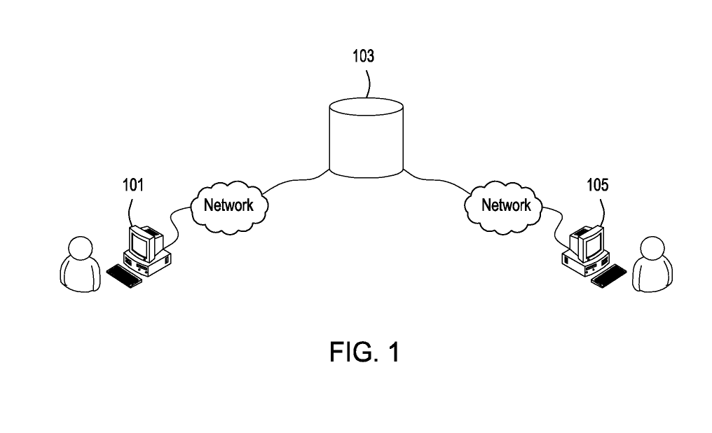

As an alternative embodiment, the present application provides an embodiment of a data encryption and decryption system of a blockchain. FIG. 1 is a schematic system diagram of a data encryption and decryption system according to an embodiment of the present application. As shown in FIG. 1, the system includes: an encryption terminal 101, a storage device 103, and a decryption terminal 105.

The encryption terminal 101 is configured to generate a block key, and encrypt to-be-uploaded data with the block key to obtain encrypted data; encrypt the block key based on a public key of a preset target object to obtain an encrypted block key corresponding to the preset target object (i.e., an encrypted block key); sign the encrypted data and the encrypted block key with the private key of the encryption terminal to generate a data signature; and upload the encrypted data, the encrypted block key, and the data signature to the storage device.

The storage device 103 is configured to store the encrypted data, the encrypted block key, and the data signature.

The decryption terminal 105 is connected to the storage device and is configured to obtain the encrypted data, the encrypted block key, and the data signature; decrypt the encrypted block key with the private key of the decryption terminal to obtain the block key; and decrypt the encrypted data with the block key to obtain the to-be-uploaded data.

In conclusion, the data encryption and decryption system of the blockchain provided by the present application is illustrated by example of an Internet electronic transaction, assuming that a terminal A used by a user A is the encryption terminal 101, a decryption terminal used by a user B is a terminal B, a service (or terminal) where a transaction platform is located is a terminal C, and a terminal used by a supervision organization is a terminal D.

Here, target objects include the terminal B, the terminal C, and the terminal D. The terminal B, the terminal C, and the terminal D are used as the decryption terminal 105.

An encryption process by the terminal A includes two phases. Phase 1: symmetric encryption, i.e., the terminal A generates the block key with an encryption and decryption method negotiated with the decryption terminal beforehand, and encrypts to-be-uploaded data based on the block key through symmetric encryption. Further, to ensure data security, the block key is encrypted with public keys for the target object terminals B, C, and D through asymmetric encryption, i.e., the encrypted block keys respectively corresponding to the terminals B, C, and D are obtained: B-Key, C-Key, and D-Key; the encrypted data and the encrypted block keys (B-Key, C-Key, and D-Key) are signed with a private key of the encryption terminal 101 to generate a data signature, and the encrypted data, the encrypted block keys, and the data signature are uploaded to a storage device.

In the above method, when receiving the encrypted data, the encrypted block keys, and the data signature, the terminals B, C, and D respectively decrypt the encrypted block keys based on private keys through asymmetric decryption to obtain block keys, and decrypt the encrypted data with the block keys based on a preset symmetric decryption algorithm in a symmetric encryption manner, so as to obtain final raw data, i.e., to-be-uploaded data by the encryption terminal in a symmetric encryption process, thereby achieving an objective of controlling data on the blockchain to only be viewed by permitted application parties or supervision parties, so as to achieve the technical effect of protecting user data privacy.

Optionally, the encryption terminal 101 and the decryption terminal 105 may be terminal devices for transaction parties performing Internet electronic transactions, include but are not limited to any one of the following: a mobile phone, a laptop, a notebook computer, a computer and the like. The storage device may be a data storage server for storing data on the Internet.

Specifically, in this embodiment, the encryption terminal may be a terminal device of either party of the transaction parties of an Internet electronic transaction and is used to upload transaction data to a blockchain. Before uploading the transaction data to the blockchain, the encryption terminal encrypts to-be-uploaded data with an internally generated block key to obtain encrypted data; encrypts a public key of an application party or a supervision mechanism (i.e., a terminal allowed to view the transaction data on the blockchain) allowed to view transaction data to obtain an encrypted block key for the application party or the supervision mechanism allowed to view transaction data, and then signs the obtained encrypted data and the encrypted block key with the private key of the encryption terminal to generate a digital signature of the encryption terminal, and finally uploads the obtained encrypted data, the encrypted block key, and the data signature to a storage device storing data on the blockchain. The application party or the supervision mechanism (i.e., a decryption terminal) allowed to view transaction data on the blockchain may obtain the encrypted data, the encrypted block key, and the data signature uploaded by the encryption terminal from the storage device storing data of the blockchain, decrypts the encrypted block key with a private key of the decryption terminal to obtain a block key of the encryption terminal, then decrypts the encrypted data with the block key to obtain the transaction data uploaded by the encryption terminal to the blockchain. The digital signature may be used to authenticate an identity of the encryption terminal.

It should be noted that the data encryption and decryption system of the blockchain provided in the present application is used for data retention, and application scenarios such as a blockchain credit system, blockchain public benefit or a blockchain smart contract is merely described by taking the above application scenarios as examples. The system for achieving the data encryption and decryption of the blockchain provided by the present application is subject to no specific limitation. |Subsequent explanations will be based on data encryption and decryption by the application party and the supervision mechanism in the blockchain.

As an optional implementation, the block key generated by the encryption terminal may be randomly generated.

Optionally, the blockchain is a distributed blockchain.

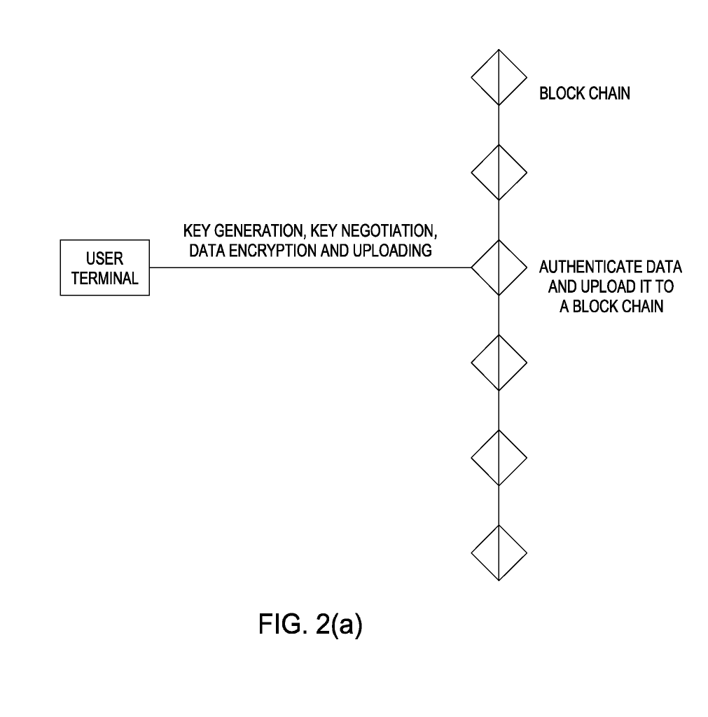

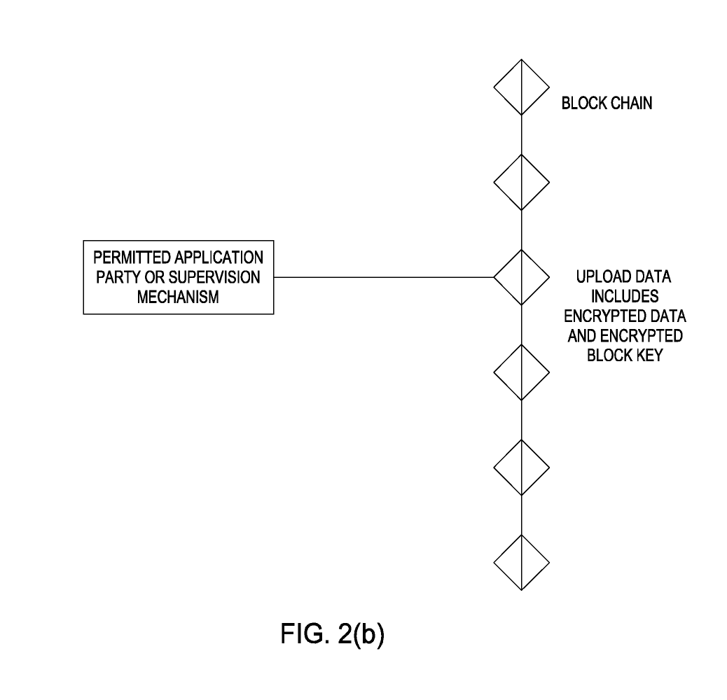

In an alternative embodiment, FIG. 2(a) is a schematic diagram of an optional method of uploading data by a user terminal to a blockchain according to an embodiment of the present application. As shown in FIG. 2(a), after generating raw data, a user terminal encrypts the raw data with an internally generated encrypted key to obtain encrypted data. Meanwhile, the application party and the supervision party that are allowed to view the raw data distribute keys and upload the encrypted data to the blockchain. Therefore, only the application party and the supervision party that are allowed to view the raw data can use a corresponding key to decrypt the encrypted data uploaded by the user terminal to the blockchain. FIG. 2(b) is a schematic diagram of an optional method of decrypting, by an application party or a supervision party, encrypted data obtained from the blockchain according to an embodiment of the present application. As shown in FIG. 2(b), the permitted application party and the supervision party may obtain the encrypted data and the encrypted block key from the chain and use their own private keys to decrypt the encrypted key, so as to obtain a data encryption key to decrypt the ciphertext data and to obtain a data plaintext.

Therefore, in the above embodiment of the present application, an encryption terminal 101 generates a block key for raw data which is encrypted and to be uploaded to a blockchain, uses the block key to encrypt the raw data which is to be uploaded to the blockchain to obtain corresponding encrypted data, uses the block key to encrypt public keys for an application party and a supervision party that are allowed to view the raw data to obtain a corresponding encrypted block key, then uses a private key of the encryption terminal to sign the encrypted data and the encrypted block key, and then uploads them to a storage device storing the blockchain. The application party and the supervision party that are allowed to view the raw data may obtain the encrypted data, the encrypted block key, and the data signature which is obtained by the decryption terminal from the storage device storing the blockchain and uploaded by the encryption terminal to the blockchain, uses a private key of a decryption terminal to decrypt the obtained encrypted block key to obtain the corresponding block key, and decrypts the encrypted data obtained on the blockchain with the block key, so as to obtain the raw data uploaded by the encryption terminal.

The solution provided by the above embodiment of the present application achieves an objective of controlling the data on the blockchain to only be viewed by permitted application parties or supervision parties, so as to achieve the technical effect of protecting user data privacy.

Accordingly, the solutions of the above embodiment provided by the present application solve the technical problems of excessive workload and complicated operation caused by implementing data access permission control in the blockchain.

In an alternative embodiment, the encryption terminal 101 may include: a key generation module, configured to randomly generate the block key; a first encryption module, configured to encrypt the to-be-uploaded data according to the block key through a symmetric cryptographic algorithm to obtain the encrypted data; a public key obtaining module, configured to obtain the public key of the preset target object through a preset data certificate; a second encryption module, configured to encrypt the block key based on the public key of the preset target object through an asymmetric cryptographic algorithm to obtain the encrypted block key; a signature generation module, configured to sign the encrypted data and the encrypted block key with a private key of the encryption terminal to generate the data signature; and a data uploading module, configured to upload the encrypted data, the encrypted block key, and the data signature to the storage device.

Specifically, in the above embodiment, the encryption terminal may: randomly generate, with a key generation module, a block key for encrypting raw data that is to be uploaded to a blockchain; encrypt, by a first encryption module through a symmetric cryptographic algorithm, raw data that is to be uploaded to a blockchain so as to obtain encrypted data; obtain, by a public key obtaining module through a preset data certificate, a public key for an application party or a supervision mechanism allowed to view the raw data that is to be uploaded to the blockchain; encrypt the block key with the public key for the application party or the supervision mechanism allowed to view the raw data by a second encryption module through an asymmetric cryptographic algorithm to obtain an encrypted block key for the application party or the supervision party sign the encrypted data and the encrypted block key by a signature generation module with a private key of the encryption terminal to generate a data signature; and finally upload, by a data uploading module, the encrypted data, the encrypted block key, and the data signature to a storage device storing the blockchain.

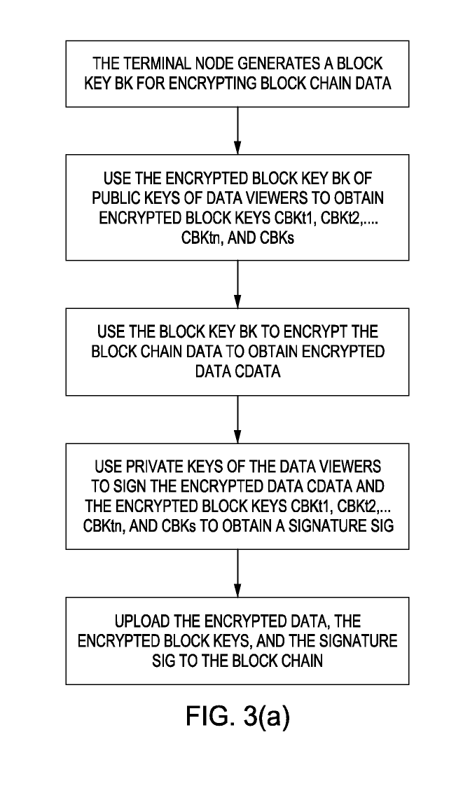

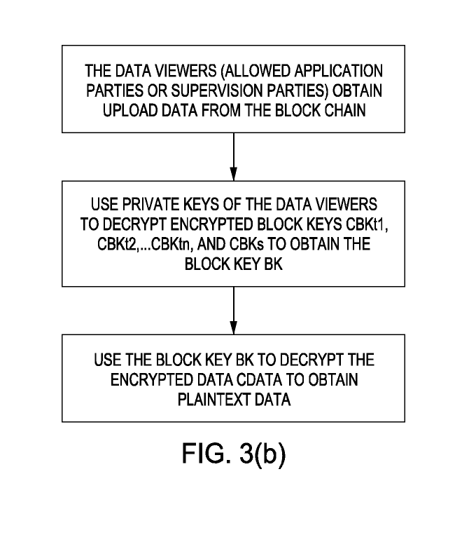

In an alternative embodiment, a user terminal shown in FIG. 2(a) is used as an example. A process of encrypting data and uploading it to the blockchain by the user terminal is shown in FIG. 3(a), in which a schematic diagram of an optional process of encrypting data and uploading it to the blockchain by a user terminal according to an embodiment of the present application. As shown in FIG. 3(a) is illustrated, the process includes the following steps:

(1) a user terminal randomly generates a block key BK, and uses a public key (such as PuKt1, PuKt2, . . . , PuKtn) for an application party allowed to view the block data and a key (PuKs) for a supervision party to encrypt the block key (BK) through an asymmetric cryptographic algorithm, so as to obtain encrypted block keys for the application parties or supervision parties, i.e., CBKt1, CBKt2, . . . CBKtn, and CBKs;

(2) the user terminal uses the block key (BK) to encrypt, through the symmetric cryptographic algorithm, the raw data that is to be uploaded by the user terminal to the blockchain, so as to obtain encrypted data CData;

(3) the user terminal uses the private key to sign (Sig) the data that is to be uploaded to the blockchain (including the encrypted data CData, encrypted block keys CBKt1, CBKt2, . . . CBKtn, and CBKs that are encrypted with the public keys for the application parties and the supervision parties allowed to view the block data); and

(4) the user terminal uploads the encrypted data CData, the encrypted block keys CBKt1, CBKt2, . . . CBKtn, and CBKs together with their signature Sig to the blockchain.

It should be noted that because the public keys (PuKt1, PuKt2, . . . PuKtn, and PuKs) for the application party and the supervision party are related to direct authentication of a specific application party and a supervision party, a PKI technology or a CA certificate of a reliable party is needed to implement binding of the application party or the supervision party with the public key, so as to extract the public key for the mechanism from the certificate.

In an alternative embodiment, the decryption terminal 105 may include: a data obtaining module, configured to obtain the encrypted data, the encrypted block key, and the data signature; a data authentication module, configured to authenticate, through the data signature, whether the encrypted data and the encrypted block key is intact; if the authentication result is positive, decrypt the encrypted block key by using the first decryption module; if the authentication result is negative, terminate the processing of the encrypted data and the encrypted block key; a first decryption module, configured to decrypt the encrypted block key based on the private key for the decryption terminal through the asymmetric cryptographic algorithm to obtain the block key generated by the encryption terminal; and a second decryption module, configured to decrypt the encrypted data based on the block key through the symmetric cryptographic algorithm to obtain the to-be-uploaded data of the encryption terminal.

Specifically, in the above embodiment, the decryption terminal may obtain the encrypted data, the encrypted block key, and the data signature obtained by the data obtaining module from the storage device storing the blockchain and uploaded by the encryption terminal to the block, authenticate, by the data authentication module, whether the encrypted data and the encrypted block key obtained by using the data signature is intact; if the authentication result is positive, decrypt the encrypted block key by using the first decryption module; if the authentication result is negative, terminate the processing of the encrypted data and the encrypted block key. After the encrypted block key is decrypted by the first decryption module, the block key is used to decrypt the encrypted data through the symmetric cryptographic algorithm so as to obtain the raw data uploaded by the encryption terminal to the blockchain.

In an alternative embodiment, FIG. 3(b) is a schematic diagram of an optional process of obtaining and encrypting data from the blockchain by an application party and a supervision party that are allowed to view the data according to an embodiment of the present application. As shown in FIG. 3(b), the process includes the following steps:

(1) the permitted application party or the supervision party (i.e., the application party or the supervision party that is allowed to view data) obtains data Dup from the blockchain, and the obtained data Dup include encrypted data CData and encrypted block keys CBKt1, CBKt2, CBKtn, and CBKs;

(2) the permitted application party or the supervision party uses respective private keys PrKt1 to decrypt the encrypted block key CBKt1 through an asymmetric cryptographic algorithm consistent with the one used to upload data to a blockchain so as to obtain the corresponding block key BK; and

(3) the plaintext data (i.e., the raw data uploaded by the encryption terminal) is obtained with the obtained key BK through a symmetric encryption algorithm consistent with the one used to upload data to a blockchain.

It should be noted that in the encryption and decryption process shown in FIG. 3(a) and FIG. 3(b), if only an application party 1 is allowed to obtain the data plaintext, the data Dup uploaded to the blockchain includes the encrypted data CData and the encrypted block key CBKt1. After obtaining the data, the application party 1 uses the private key PrKt1 to decrypt the encrypted block key CBKt1 through the asymmetric cryptographic algorithm consistent with the one used to upload data to a blockchain to obtain the block key BK, and decrypts the data CData with the block key BK through the symmetric encryption algorithm consistent with the one used to upload data to a blockchain to obtain the plaintext Data.

Further, as an alternative embodiment, in the above transaction, if a supervision party 1 needs to participate to supervise the transaction data in an operation, the block data Dup that is subsequently uploaded to the blockchain includes CData and encrypted block keys CBKt1 and CBKs1. After obtaining the data, the application party 1 and the supervision party 1 use their respective private keys PrKt1 and PrKs1 to decrypt the encrypted block keys CBKt1 and CBKs1 through the asymmetric cryptographic algorithm consistent with the one used to upload data to a blockchain, so as to obtain corresponding block key BK. The application party 1 and the supervision party 1 use respectively block key BK to decrypt data CData through the symmetric encryption algorithm consistent with the one used to upload data to a blockchain, so as to obtain the plaintext data (Data).

Optionally, if there is no need to be supervised by supervision party 1 for some reason in the subsequent operation, then the encrypted block key CBKs1 is removed from the block data that is subsequently uploaded to the blockchain. Therefore, the supervision party 1 cannot obtain the data decryption key BK, and thus cannot decrypt the block data plaintext.

It should be noted that the above embodiments can be applied to scenarios where the amount of data uploaded to the blockchain is small, such as public welfare donations, equity certificates, and real estate certificates. In addition, the number of applications and supervision mechanisms involved in viewing may also not be too large, and should be in the range of a few to a few dozen or so. If the number is too large, the block size of the blockchain may fail to support it. These factors need to be considered when the solutions of the present application are used.

In the solutions disclosed in the above embodiments of the present application, the symmetric encryption algorithm is used to encrypt the data uploaded to the blockchain, and the data uploaded to the blockchain is encrypted and stored, and the asymmetric cryptographic algorithm is used to encrypt and distribute the key for the application party or supervision party. The key management method is used to control application party or supervision party that can view data, and keep the data confidential to other application parties or supervision parties that do not have the data viewing permission. It can be seen that this solution can achieve targeted data uploaded to the blockchain publicly, protect the security of the data uploaded to the blockchain, can meet the need for protecting user data privacy in blockchain application scenarios such as public welfare, credit investigation, and multi-party lending, and allows related supervision mechanisms to obtain sensitive data on these chains. In addition, the above embodiment of the present application can achieve the following technical effects:

(1) the data in each block is a randomly generated different encryption key, which can achieve “one block, one encryption, “and one block, one encryption” greatly increases the difficulty of cipher cracking; and

(2) a supervision party can participate in the next block when needed. The monitor can only detect the data of the subsequent block after adding; a certain supervision party may be removed when it is not needed, and the supervision party cannot view the block transaction data at the beginning of the next block.

### Embodiment 2

According to this embodiment of the present application, an embodiment of a data encryption method is further provided. The data encryption method provided by this embodiment may be applied to a data encryption and decryption system provided in Embodiment 1 of the present application, includes but is not limited to application scenarios described in Embodiment 1 of the present application. It should be noted that the steps shown in the flowchart of the drawings may be performed in a computer system such as a set of computer-executable instructions; and although a logical sequence is shown in the flowchart, in some cases, the illustrated or described steps may be performed in an order different from the one described herein.

Since anyone can participate in the blockchain network, each device can be used as a node, and each node is allowed to obtain a complete database copy. Therefore, all data information on the blockchain is public. In order to protect the privacy of user data, a complicated data read permission control system is used in the prior art to control the blockchain at each node of the blockchain, or the transaction data is stored in a trusted third party off the chain to control read permission of transaction data on the blockchain.

It can be seen that the existing solution of controlling read permission of transaction data on the blockchain is essentially using traditional security boundary control to implement data protection. Setting a complicate data read permission control system on each node of the blockchain risks all data to be leaked when the system permission of a certain node is broken into. There is also the risk of system permission being broken into when storing transaction data in a trusted third party off the chain and relying on a third-party device.

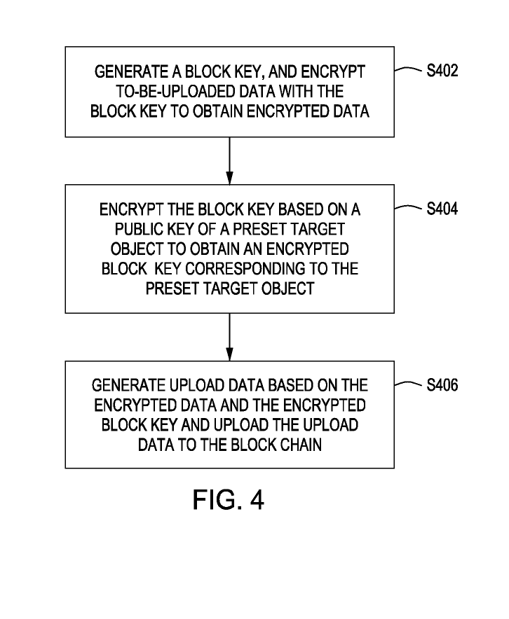

In the above application scenario, the present application provides a data encryption method shown in FIG. 4. FIG. 4 is a flowchart of a data encryption method according to an embodiment of the present application, including the following steps:

Step S402: Generate a block key, and encrypt to-be-uploaded data with the block key to obtain encrypted data.

As an alternative embodiment, the to-be-uploaded data may be any online or offline electronic transaction data, includes but is not limited to transaction data for transfer and payment over Internet. The block key may be a key for encrypting data of a certain block for storing transaction data on the blockchain. In an optional implementation, the block key may be generated randomly. After the block key is generated, the to-be-uploaded data to be uploaded to the blockchain is encrypted based on the block key, so as to obtain the encrypted data.

It should be noted that the blocks in the blockchain is generated sequentially in chronological order, each block records transaction data in a block generation time period. In order to ensure that the transaction data recorded in the block is not accessed or viewed by any node in the blockchain network, the confidential transaction data that is recorded by the block may be encrypted. The block key refers to the key for encrypting data uploaded to the block of the blockchain.

Step S404: Encrypt the block key based on a public key of a preset target object to obtain an encrypted block key corresponding to the preset target object.

As an alternative embodiment, the preset target object may be an application party or a supervision mechanism allowed to view the transaction data uploaded to the blockchain. In order to designate which user can view the data uploaded to the blockchain, the generated block key is encrypted by using a public key for each application party or supervision party (the supervision mechanism) allowed to view data, so as to obtain the encrypted block key corresponding to each application party or supervision party that is allowed to view the transaction data uploaded to the blockchain.

Step S406: Generate upload data based on the encrypted data and the encrypted block key and upload the upload data to the blockchain.

As an alternative embodiment, the to-be-uploaded data that is to be uploaded to the blockchain is encrypted by using the generated block key to obtain the encrypted data, and the generated block key is encrypted by using the public key for each application party or supervision party (the supervision mechanism) allowed to view the transaction data uploaded to the blockchain, so as to obtain the encrypted block key corresponding to each application party or supervision party that is allowed to view the transaction data uploaded to the blockchain. Then the upload data to be uploaded to the blockchain is generated according to the obtained encrypted data and the encrypted block key corresponding to the application party or the supervision party and the upload data is uploaded to the blockchain.

Therefore, in this embodiment of the present application, a block key for raw data used to be encrypted and uploaded to a blockchain is generated, and the block key is used to encrypt the raw data to be uploaded to the blockchain so as to obtain corresponding encrypted data, and the block key is encrypted with a public key for an application party and a supervision party that are allowed to view the raw data to obtain corresponding encrypted block key. Then a private key for an encryption terminal is used to sign the encrypted data and the encrypted block key, and the encrypted data and the encrypted block key are uploaded to the blockchain.

The solution provided by the above embodiment of the present application achieves an objective of controlling the data on the blockchain to only be viewed by permitted application parties or supervision parties, so as to achieve the technical effect of protecting user data privacy.

Accordingly, the solutions of the above embodiment provided by the present application solve the technical problems of excessive workload and complicated operation caused by implementing data access permission control in the blockchain.

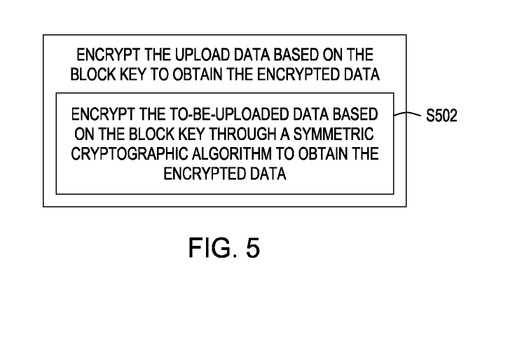

In an optional implementation, as shown in FIG. 5, to-be-uploaded data is encrypted based on a block key to obtain encrypted data, including:

Step S502: Encrypt the to-be-uploaded data based on the block key through a symmetric cryptographic algorithm to obtain the encrypted data, where the symmetric cryptographic algorithm is used for an encryption terminal and a decryption terminal to perform encryption and decryption with a same key.

Specifically, in this embodiment, after the block key for encrypting data of a certain block of storing transaction data on the blockchain is generated, the symmetric cryptographic algorithm is used to encrypt the to-be-uploaded data to obtain the encrypted data.

It should be noted that the data of a certain block that is to be uploaded to the blockchain is encrypted based on the block key through the symmetric encryption algorithm, so that an application party or a supervision party that is allowed to view the data of the block decrypts the encrypted data based on the decrypted block key so as to further obtain raw data in the block.

Optionally, the employed symmetric encryption algorithm may include but is not limited to algorithms such as DES and AES.

In the above embodiment, a data provider generates a random symmetric encrypted key, and uses the symmetric encrypted key to encrypt the data uploaded to the blockchain.

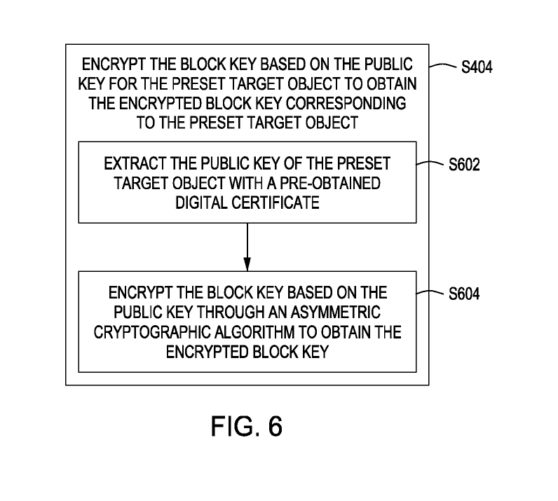

In an optional implementation, as shown in FIG. 6, step S404 of encrypting the public key of the preset target object based on the block key to obtain the encrypted block key corresponding to the preset target object includes:

Step S602: Extract the public key for the preset target object through a pre-obtained digital certificate.

Step S604: Encrypt the block key based on the public key through an asymmetric cryptographic algorithm to obtain the encrypted block key, where the asymmetric cryptographic algorithm is configured to encrypt to-be-encrypted data at the encryption terminal with the public key for the decryption terminal, and decrypt the to-be-encrypted data at the decryption terminal with a private key for the decryption terminal,

Specifically, in the above embodiment, after the block key for encrypting the data of a certain block for storing transaction data on the blockchain is generated, a public key for an application party or a supervision party (a supervision mechanism) allowed to view the transaction data uploaded to the blockchain is obtained. The generated block key is encrypted with the obtained public key through the asymmetric cryptographic algorithm to obtain the encrypted block key corresponding to each application party or supervision party that is allowed to view the transaction data uploaded to the blockchain. Optionally, the public key for each application party or supervision party (the supervision mechanism) allowed to view the transaction data uploaded to the blockchain may be extracted according to a pre-obtained digital certificate.

It should be noted that the asymmetric encryption algorithm refers to respectively using two passwords in “encryption” and “decryption” processes, where the public key is referred to as “a public key”, and the non-public key is referred to as “a private key”. In the above embodiment, the public key for the application party or the supervision party is public to the blockchain, and each node on the blockchain can view the public key for the application party or the supervision party. Therefore, when data uploaded by a certain node needs to designate an application party or a supervision party that is allowed to view the data, the block key is encrypted with the public key for the application party or the supervision party that is allowed to view data. Therefore, only the private key for the application party or the supervision party that is allowed to view data can decrypt the encrypted block key so as to decrypt the transaction data with the block key.

Optionally, the used asymmetric encryption algorithm may include but is not limited to algorithms such as RSA, Elgamal, D-H, and ECC.

In the above embodiment, the public keys for data viewers are used to encrypt the generated block key, an encrypted block key corresponding to each application party or supervision party that is allowed to view the transaction data uploaded to the blockchain is generated, and the application party or the supervision party is enabled to use respective encrypted block keys to decrypt data obtained from the blockchain so as to further implement formulation.

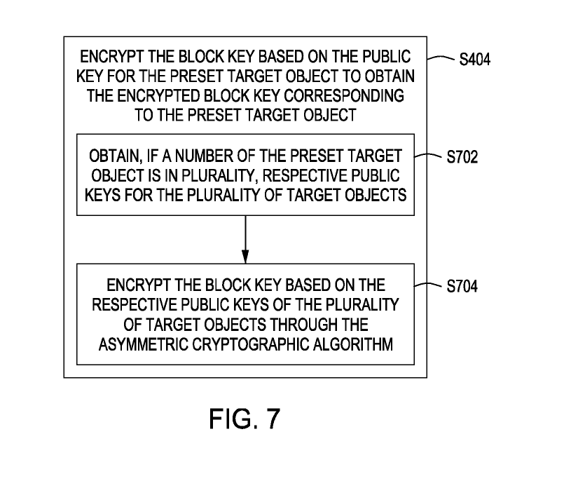

In an optional implementation, as shown in FIG. 7, step S404 of encrypting the block key based on the public key for the preset target object to obtain the encrypted block key corresponding to the preset target object includes:

Step S702: Obtain, if a number of the preset target object is in plurality, respective public keys for the plurality of target objects.

Step S704: Encrypt the block key based on the respective public keys for the plurality of target objects through the asymmetric cryptographic algorithm to obtain a plurality of block encrypted keys.

Specifically, in the above embodiment, the preset target object may be a user allowed to view data on the blockchain, and may be an application party or a supervision party. When there are a plurality of users allowed to view the data on the blockchain, for example, a plurality of application parties or a plurality of application parties and supervision parties, in a process of encrypting the block key with the public key for the preset target object, public keys for the application parties and the supervision parties are obtained, and the public keys are used to encrypt the block key through the asymmetric cryptographic algorithm to obtain the encrypted block keys for the application parties and the supervision parties.

In an alternative embodiment, assuming that in a certain transaction, users allowed to view the transaction data stored in a certain block on the blockchain are an application party 1, an application server 2, and a supervision party 1, public keys for the application party 1, the application party 2, and the supervision party 1 are obtained respectively, and the public keys for the application party 1, the application party 2, and the supervision party 1 can be used to encrypt the block key for the block through the asymmetric cryptographic algorithm to obtain a plurality of encrypted block keys.

In the above embodiment, it may be implemented that one or more users allowed to view the transaction data stored in a certain block on the blockchain are designated, so as to ensure that the transaction data of the block can only be viewed by the transaction data of the block, so as to further ensure data privacy.

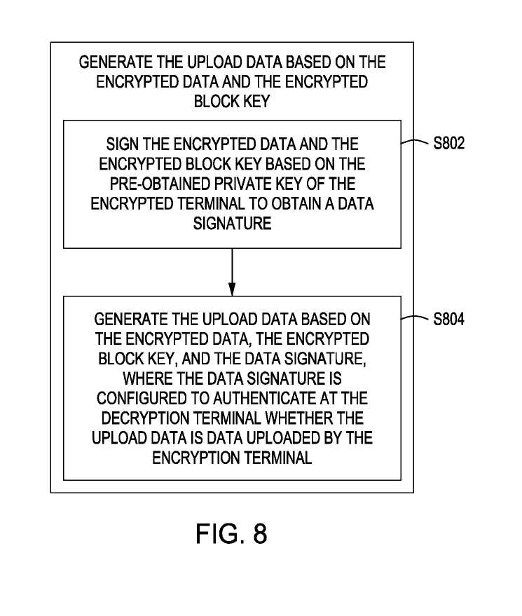

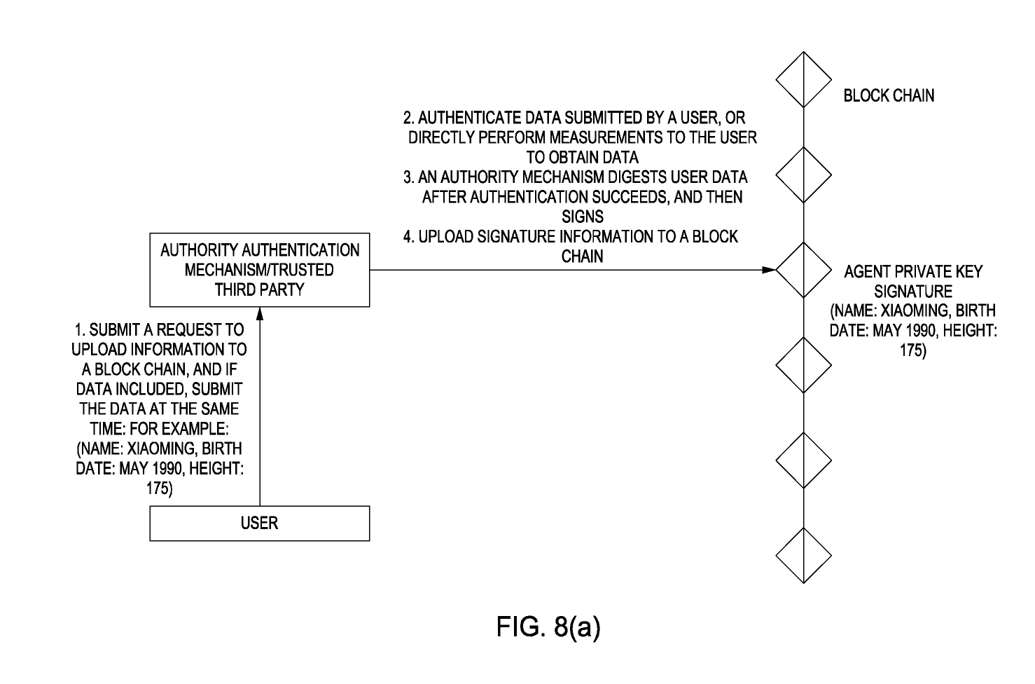

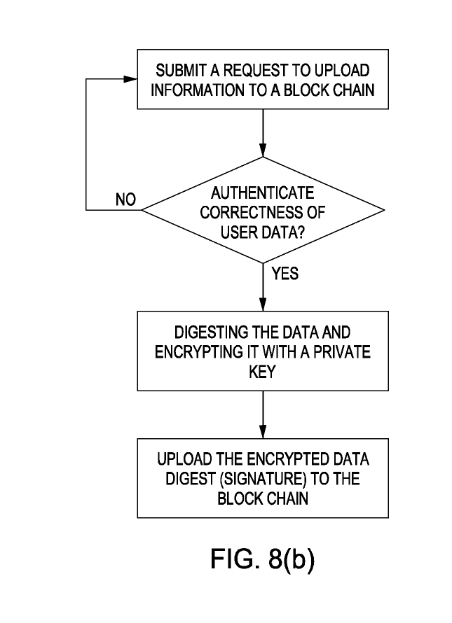

To facilitate the decryption terminal to authenticate that the obtained data is actually from the encryption terminal, in an optional solution, as shown in FIG. 8, the generating the upload data based on the encrypted data and the encrypted block key includes:

Step S802: Sign the encrypted data and the encrypted block key based on the pre-obtained private key of the encryption terminal to obtain a data signature.

Step S804: Generate the upload data according to the encrypted data, the encrypted block key, and the data signature, where the data signature is configured to authenticate at the decryption terminal whether the upload data is data uploaded by the encryption terminal.

Specifically, in the above embodiment, the sender providing data uses the private key to add a digital to the uploaded encrypted data and the encrypted block key, and the decryption terminal may authenticate, with the data signature, whether the obtained upload data is uploaded by the encryption terminal.

In the above embodiment, in an aspect, it may be determined that the data obtained by the decryption terminal is actually sent by the encryption terminal; in another aspect, integrity of the obtained may be authenticated.

In conclusion, the data encryption method provided by the present application is specifically as follows.

In an optional implementation, before encrypting the to-be-uploaded data based on the block key to obtain the encrypted data in step S402, the data encryption method provided in the present application further includes:

Step S399: Receive a request to upload information to a blockchain, where the request to upload information to a blockchain includes the to-be-uploaded data.

Step S400: Inspect, based on a preset condition, whether the to-be-uploaded data is correct.

Step S401: Encrypt the to-be-uploaded data according to the block key if an inspection result is correct.

Further, based on the steps S399 to S401, optionally, the step S402 of encrypting the to-be-uploaded data based on the block key to obtain the encrypted data includes:

Step 1: Encrypt digest data in the to-be-uploaded data with the block key to obtain the encrypted data.

Specifically, FIG. 8(a) is a flowchart of uploading data to a blockchain with a data encryption method according to an embodiment of the present application. As shown in FIG. 8(a), a user submits a request to upload data to a blockchain, and an authority mechanism or a trusted third party authenticates user data, digests the user data, encrypts the user data with the private key, and finally uploads the encrypted digest to the blockchain.

The authority mechanism or the trusted third party may be a location where an encryption terminal in the present application located. Digesting the user data and encrypting it with the private key for the authority mechanism or the trusted third party may include: encrypting the to-be-uploaded data with the block key in step S402 to obtain the encrypted data. For the encryption process, reference can be made to FIG. 2(a) and FIG. 3(a).

An example of encrypting user terminal data and uploading it to a blockchain by an authority mechanism is used. With reference to FIG. 8(a), it is a flowchart of encrypting data and uploading it to a blockchain with a data encryption method according to an embodiment of the present application. As shown in FIG. 8(b), a process of encrypting data and uploading it to a blockchain is as follows:

1. A user submits a request to upload information to a blockchain; and submits data at the same time if desired.

2. An authority mechanism authenticates the data submitted by the user, or directly measures the user to obtain the data, such as a direct blood test in the hospital.

3. After data authentication by the authority mechanism succeeds, an digest algorithm is used to digest the data. The digest algorithm may include SHA256, and then the private key for the authority mechanism is used to encrypt the digest.

4. The authority mechanism uploads the encrypted digest to the blockchain.

It should be noted that, in the foregoing method embodiments, for simplicity of description, they are all expressed as a series of action combinations, but a person skilled in the art should understand that the present application is not limited to the described action sequence. Because according to the present application, certain steps may be performed in other orders or simultaneously. Secondly, a person skilled in the art should also understand that the embodiments described in the specification are all preferred embodiments, and the involved actions and modules are not necessarily required in the present application.

From the description of the above embodiments, a person skilled in the art can clearly understand that the method for controlling data transmission according to the above embodiments can be implemented by software plus a necessary general hardware platform. Certainly, it can be implemented by the hardware, but the former is a better implementation in many cases. Based on such understanding, the part of the technical solution of the present application that essentially or contributing to the prior art may be embodied in the form of a software product. The computer software product is stored in a storage medium (such as ROM/RAM, a magnetic disk, and an optical disc etc.), including instructions for enabling a terminal device (which may be a mobile phone, a computer, a server, or a network device, etc.) to perform the methods described in the embodiments of the present application.

### Embodiment 3

According to this embodiment of the present application, an embodiment of a data decryption method is further provided. The data decryption method provided in this embodiment may be applied to the data encryption and decryption system provided by Embodiment 1 of the present application, includes but is not limited to an application scenario described in Embodiment 1 of the present application. As an alternative embodiment, encrypted data obtained by using the data encryption method in Embodiment 2 may be decrypted. It should be noted that the steps shown in the flowchart of the drawings may be executed in a computer system such as a set of computer executable instructions. Moreover, although the flowchart shows a logic sequence, in some cases, the shown or described steps may be executed in a different order.

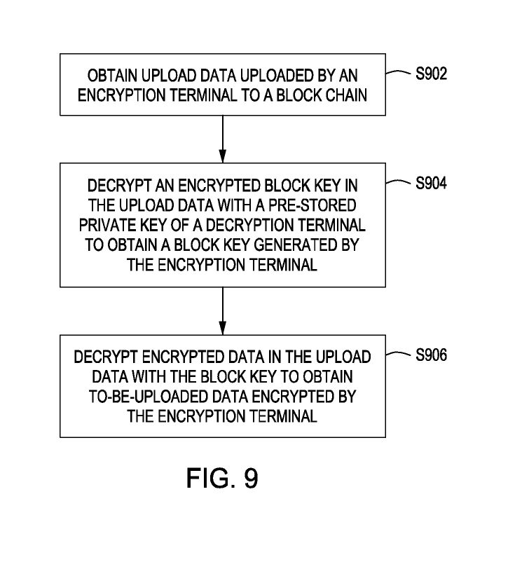

The present application provides a data decryption method as shown in FIG. 9. FIG. 9 shows a flowchart of a data decryption method according to an embodiment of the present application, including the following steps:

Step S902: Obtain upload data uploaded by an encryption terminal to a blockchain.

As an alternative embodiment, the upload data on the blockchain may include encrypted data and an encrypted block key, where the encrypted data refers to transaction data encrypted with the block key, and the encrypted block key refers to a block key encrypted with a public key of a decryption terminal. The block key is a key generated by an encryption terminal and used for encrypting data of a certain block for storing data on the blockchain.

Step S904: Decrypt an encrypted block key in the upload data with a pre-stored private key of a decryption terminal to obtain a block key generated by the encryption terminal.

Specifically, in the above step, when the encrypted data and the encrypted block key uploaded by the encryption terminal to the blockchain are obtained, the decryption terminal may decrypt the encrypted block key with its own private key, so as to obtain the block key generated by the encryption terminal and used for encrypting data of a certain block for storing the transaction data on the blockchain.

Step S906: Decrypt encrypted data in the upload data with the block key to obtain to-be-uploaded data encrypted by the encryption terminal.

Specifically, in the above step, when the decryption terminal obtains, based on its own private key, the block key generated by the encryption terminal and used for encrypting data of a certain block for storing the transaction data on the blockchain, and decrypts the encrypted data in the obtained upload data with the block key so as to obtain raw data uploaded by the encryption terminal to the blockchain.

From the above description, it can be seen that in the above embodiment of the present application, after the encrypted data obtained by encrypting the raw data uploaded by the encryption terminal to the blockchain with the block key is obtained and the encrypted block key obtained by encrypting the block key with the public key for the user allowed to view the raw data is obtained, the private key for the decryption terminal is used to decrypt the block decryption key to obtain the block key used by the encryption terminal to encrypt the raw data, and the block key is used to decrypt the obtained encrypted data to obtain the raw data uploaded by the encryption terminal.

The solutions provided in the above embodiment of the present application achieves an objective of viewing data uploaded to the blockchain only by allowed application parties or supervision parties, so as to implement the technical effect of protecting user data privacy.

Accordingly, the solutions of the above embodiment provided by the present application solve the technical problems of excessive workload and complicated operation caused by implementing data access permission control in the blockchain.

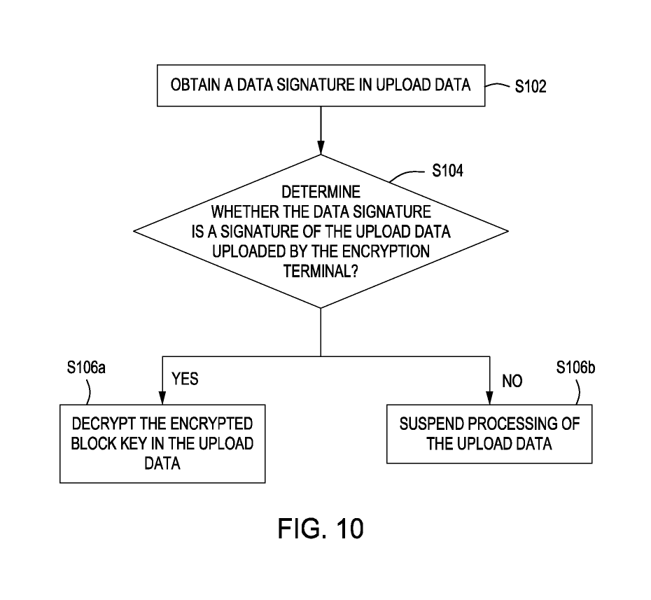

In an alternative embodiment, as shown in FIG. 10, before decrypting the encrypted block key in the upload data with the pre-stored private key for the decryption key, the method further includes the following steps:

Step S102: Obtain a data signature in the upload data.

Step S104: Determine whether the data signature is a signature of the upload data uploaded by the encryption terminal.

Step S106a: Decrypt the encrypted block key in the upload data if a determining result is yes.

Step S106b: Suspend processing of the upload data if the determining result is no.

As an alternative embodiment, the data signature may be a digital signature added by the encryption terminal to the encrypted data and the encrypted block key for data that is to be uploaded to the blockchain. After the upload data is obtained, it is determined whether the data signature obtained in the upload data is a signature of the upload data uploaded by the encryption terminal. If the data signature obtained in the upload data is a signature of the upload data uploaded by the encryption terminal, the encrypted block key in the upload data is decrypted; otherwise, the obtained upload data is not processed.

In the above embodiment, it is authenticated whether the data obtained by the decryption terminal is from the encryption terminal, and the data is decrypted when the authentication succeeds, thereby in one aspect, ensuring reliability and completeness of a data source, and in another aspect, reducing resource waste caused by decryption errors of the decryption terminal.

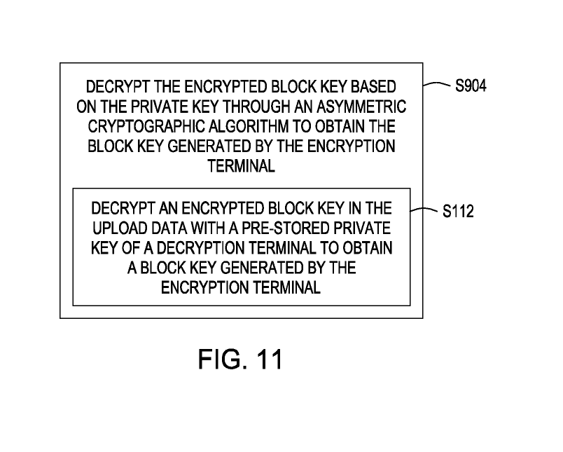

In an alternative embodiment, as shown in FIG. 11, the step S904 of decrypting an encrypted block key in the upload data with a pre-stored private key of a decryption terminal to obtain a block key generated by the encryption terminal includes:

Step S112: Decrypt the encrypted block key based on the private key through an asymmetric cryptographic algorithm to obtain the block key generated by the encryption terminal.

Specifically, in the above embodiment, because in the upload data obtained by the decryption terminal, the encrypted block key is encrypted by the encryption terminal with the public key for the decryption terminal, the decryption terminal may use its own private key to decrypt the encrypted block key through the asymmetric cryptographic algorithm, so as to obtain the block key generated by the encryption terminal and used for encrypting data of a certain block for storing the transaction data on the blockchain.

As an alternative embodiment, the asymmetric cryptographic algorithm is configured to encrypt to-be-encrypted data at the encryption terminal with the public key for the decryption terminal and decrypt the to-be-encrypted data at the decryption terminal side with the private key for the decryption terminal.

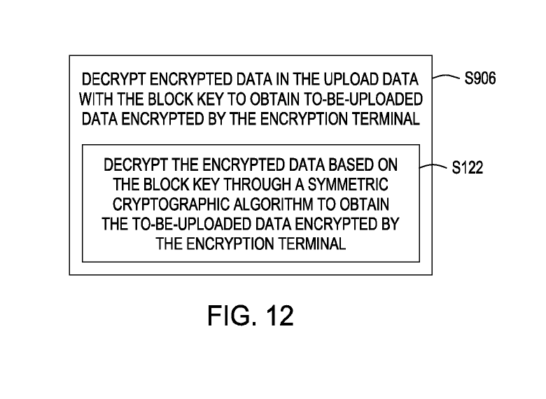

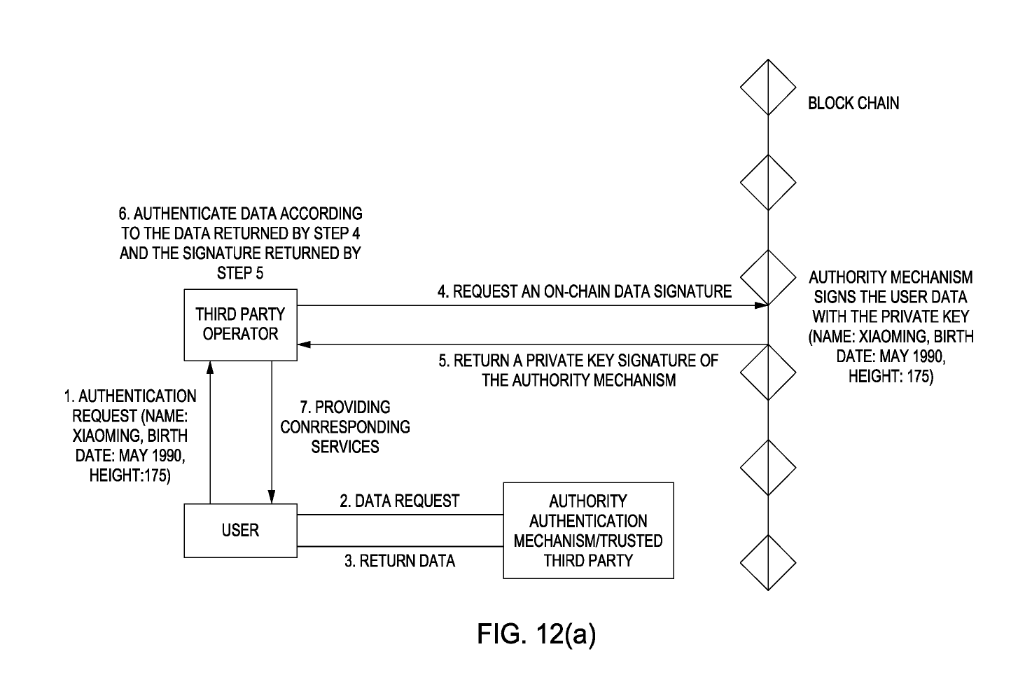

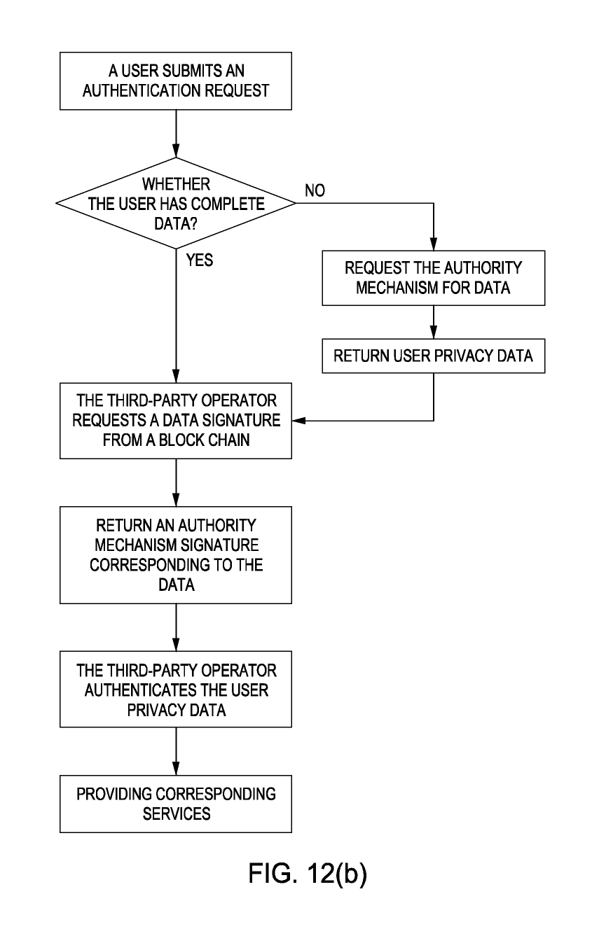

In an alternative embodiment, as shown in FIG. 12, the step S906 of decrypting the encrypted data in the upload data with the block key to obtain the to-be-uploaded data encrypted by the encryption terminal includes:

Step S122: Decrypt the encrypted data based on the block key through a symmetric cryptographic algorithm to obtain the to-be-uploaded data encrypted by the encryption terminal.

Specifically, in the above embodiment, when the decryption terminal obtains, with its own private key, the block key generated by the encryption terminal and used for encrypting data of a certain block for storing the transaction data on the blockchain, the block key may be used to decrypt the encrypted data through the symmetric cryptographic algorithm to obtain raw data encrypted by the encryption terminal.

As an alternative embodiment, the symmetric cryptographic algorithm is configured to encrypt and decrypt by the encryption terminal and the decryption terminal with a same key.

In conclusion, corresponding to the data encryption method of Embodiment 2, an application process of the data decryption method provided in this embodiment of the present application is specifically as follows.

In an optional implementation, before obtaining the upload data uploaded by the encryption terminal to the blockchain in step S902, the data decryption method provided in this embodiment of the present application further includes:

Step S897: Receive a data service request.

Step S898: Return user data service information and requirement information according to the data service request.

Step S899: Receive user information returned based on the user data service information and requirement information and authenticate the user information.

Step S900: Send a user data request message to the encryption terminal if an authentication result is that the user information is incomplete.

Step S901: Receive the user data sent by the encryption terminal.

Further, optionally, the step S902 of obtaining upload data uploaded by an encryption terminal to a blockchain includes:

Step 1: Obtain digest data in the upload data of the blockchain.

Optionally, after obtaining to-be-uploaded data encrypted by the encryption terminal in step S906, the data decryption method further includes:

Step S907: Authenticate the digest data and the to-be-uploaded data.

Step S908: Provide corresponding services after successful authentication of the digest data and the to-be-uploaded data according to a preset condition succeeds.

Specifically, FIG. 12(a) is a schematic diagram of data authentication of a data decryption method according to an embodiment of the present application. As shown in FIG. 12(a), a user requests service at a third-party operator (i.e., a location of the decryption terminal mentioned in this embodiment), and the third-party operator authenticates user privacy data.

The user submits a service request to the third-party operator. If there exists data, the data may be submitted at the same time. The third-party operator obtains a signature corresponding to the data from the chain. If specific data needs to be obtained, data is queried from an authority mechanism (i.e., a location at which the encryption terminal located in this embodiment of the present application), and then the user data and the corresponding signature of the authority mechanism are authenticated.

With reference to FIG. 12(a), it is a schematic diagram of privacy data authentication of a data decryption method according to an embodiment of the present application. As shown in FIG. 12(b), a process of decrypting the on-chain data by the third-party is as follows:

1. the user requests a service from a third-party operator, the third-party operator submits a request for authenticating user information, and the user submits an authentication request, attached with information of to-be-authenticated data;

2. if the user does not have complete privacy data, private information needs to be obtained from an authority mechanism, either online or offline, depending on specific cases;

3. the authority mechanism returns user privacy data information;

4. the third-party operator requests an encrypted digest of the user's privacy data from the distributed blockchain (authority's signature of the privacy data);

5. the distributed blockchain returns the signature information of the data to the third-party operator;

6. the third-party operator authenticates the user privacy data and signature information of the privacy data with the public key for the authority mechanism; and

7. corresponding services are provided for the user when the authentication succeeds.

Based on the above description, a process of uploading a privacy data signature to a blockchain includes: a user provides data for an authority mechanism for authentication, and a data digest is generated after the authentication succeeds; the authority mechanism encrypts the data digest with a private key to generate a signature, and then the signature of the data is uploaded to the blockchain.

A process of authenticating the privacy data is that: a user provides privacy data for a third-party to authenticate, the third-party operator obtains a signature of the authority mechanism on the user privacy data through a blockchain, and a public key for the authority mechanism is used to authenticate whether the privacy data is consistent with the data signature to determine correctness of the privacy data.

In the data decryption method provided by Embodiment 2 and this embodiment, the authority mechanism is used to digest the user privacy data, and it is uploaded to the blockchain after being encrypted with the private key (equivalent to signing the privacy data), and the data is not uploaded to the blockchain. In the present application, the data is digested, signed, and uploaded to the blockchain, and the data is in an authority mechanism. Only the user can obtain data from the authority mechanism, and the data does not have a third-party operator, thereby ensuring security of privacy data.

Secondly, the signature of the authority mechanism is uploaded to the blockchain, therefore, the authority mechanism cannot deny confirming and recording of certain data at certain time.

Moreover, the third-party operator can perform multi-party authentication from a plurality of authority mechanisms to improve authentication correctness.

It can be seen that the present application can authenticate the user privacy data under the premise of effectively protecting the user's privacy data, and can solve the requirement to protect users in blockchain application scenarios such as personal health status query, personal credit query, and personal asset query in which data privacy needs to be protected and provided to the third-party operator for data authentication.

Besides, in data authentication process of the present application, each time the user privacy data needs to be authenticated, the third-party operator applies for an authentication request for the user data from the authority mechanism, and the third-party authority returns an authentication result to the third-party operator after authentication.

It should be noted that, in the foregoing method embodiments, for simplicity of description, they are all expressed as a series of action combinations, but a person skilled in the art should understand that the present application is not limited to the described action sequence. Because according to the present application, certain steps may be performed in other orders or simultaneously. Secondly, a person skilled in the art should also understand that the embodiments described in the specification are all preferred embodiments, and the involved actions and modules are not necessarily required in the present application.

From the description of the above embodiments, a person skilled in the art can clearly understand that the method for controlling data transmission according to the above embodiments can be implemented by software plus a necessary general hardware platform. Certainly, it can be implemented by the hardware, but the former is a better implementation in many cases. Based on such understanding, the part of the technical solution of the present application that essentially or contributing to the prior art may be embodied in the form of a software product. The computer software product is stored in a storage medium (such as ROM/RAM, a magnetic disk, and an optical disc etc.), including instructions for enabling a terminal device (which may be a mobile phone, a computer, a server, or a network device, etc.) to perform the methods described in the embodiments of the present application.

### Embodiment 4

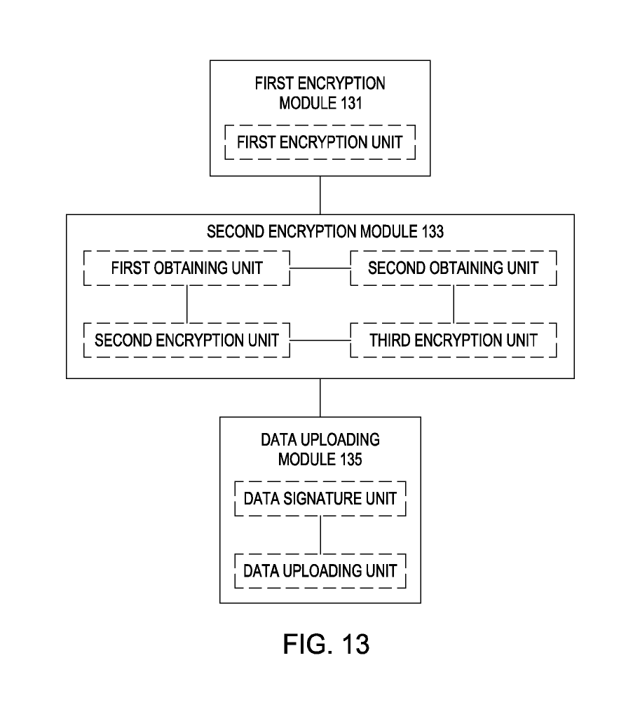

According to this embodiment of the present application, an embodiment of an apparatus for implementing a data encryption method in Embodiment 2 is further provided. FIG. 13 is a flowchart of a data encryption apparatus according to an embodiment of the present application. As shown in FIG. 13, the apparatus includes a first encryption module 131, a second encryption module 133, and a data uploading module 135.

The first encryption module 131 is configured to generate a block key and encrypt to-be-uploaded data based on the block key to obtain encrypted data.

The second encryption module 133 is configured to encrypt the block key based on a public key of a preset target object to obtain an encrypted block key corresponding to the preset target object.

The data uploading module 135 is configured to generate upload data based on the encrypted data and the encrypted block key and upload the upload data to a blockchain.

It should be noted that the first encryption module 131, the second encryption module 133, and the data uploading module 135 correspond to steps S402 to S406 in Embodiment 2. Examples implemented by the above modules and corresponding steps are same as application scenarios, but are not limited to content disclosed in the above Embodiment 2. It should be noted that the modules, as a part of the apparatus, may be executed in a computer system such as a set of computer-executable instructions.

Therefore, in the above embodiment of the present application, the first encryption module 131 generates a block key used for encrypting raw data that is to be uploaded to the blockchain, and encrypts, with the block key, the raw data that is to be uploaded to the blockchain to obtain corresponding encrypted data. The block key is encrypted by the second encryption module 133 with public keys for an application party and a supervision party that are allowed to view the raw data so as to obtain corresponding encrypted block key, then a private key for an encryption terminal is used to sign the encrypted data and the encrypted block key, and the encrypted data and the encrypted block key are uploaded to the blockchain.

The solution provided by the above embodiment of the present application achieves an objective of controlling the data on the blockchain to be only viewed by permitted application parties or supervision parties, so as to achieve the technical effect of protecting user data privacy.

Accordingly, the solutions of the above embodiment provided by the present application solve the technical problem of excessive workload and complicated operation caused by implementing data access permission control in the blockchain.

In an optional implementation, as shown in FIG. 13, the first encryption module includes a first encryption unit, configured to encrypt the to-be-uploaded data based on the block key through a symmetric cryptographic algorithm to obtain the encrypted data, where the symmetric cryptographic algorithm is configured to encrypt and decrypt by an encryption terminal and a decryption terminal with a same key.

It should be noted that the first encryption unit corresponds to step S502 in Embodiment 2. Examples implemented by the above module and corresponding steps are the same as application scenarios, but are not limited to content disclosed by the above Embodiment 2. It should be noted that the modules, as a part of the apparatus, may be executed in a computer system such as a set of computer-executable instructions.

In an optional implementation, as shown in FIG. 13, the second encryption module includes: a first obtaining unit, configured to extract the public key for the preset target object through a pre-obtained digital certificate; and a second encryption unit, configured to encrypt the block key based on the public key through an asymmetric cryptographic algorithm to obtain the encrypted block key, wherein the asymmetric cryptographic algorithm is configured to be used by the encryption terminal to encrypt to-be-encrypted data with the public key of the decryption terminal, and by the decryption terminal to decrypt the to-be-encrypted data with a private key of the decryption terminal.

It should be noted that the first obtaining unit and the second encryption unit correspond to steps S602 to S604 in Embodiment 2. Examples implemented by the above module and corresponding steps are the same as application scenarios, but are not limited to content disclosed in the above Embodiment 2. It should be noted that the modules, as a part of the apparatus, may be executed in a computer system such as a set of computer-executable instructions.

In an optional implementation, as shown in FIG. 13, the second encryption module includes: a second obtaining unit, configured to obtain, if a number of the preset target object is in plurality, respective public keys of the plurality of target objects; and a third encryption unit, configured to encrypt the block key based on the respective public keys of the plurality of target objects through the asymmetric cryptographic algorithm to obtain a plurality of encrypted block keys.

It should be noted that the second obtaining unit and the third encryption unit correspond to steps S702 to S704 in Embodiment 2. Examples implemented by the above module and corresponding steps are the same as application scenarios, but are not limited to content disclosed in the above Embodiment 2. It should be noted that the modules, as a part of the apparatus, may be executed in a computer system such as a set of computer-executable instructions.

In an optional implementation, as shown in FIG. 13, the data uploading module includes: a data signature unit, configured to sign the encrypted data and the encrypted block key based on the pre-obtained private key of the encryption terminal to obtain a data signature; and a data uploading unit, configured to generate the upload data based on the encrypted data, the encrypted block key, and the data signature, where the data signature is configured to authenticate at the decryption terminal whether the upload data is data uploaded by the encryption terminal.

It should be noted that the data signature unit and the data uploading unit correspond to steps S802 to S804 in Embodiment 2. Examples implemented by the above module and corresponding steps are the same as application scenarios, but are not limited to content disclosed in the above Embodiment 2. It should be noted that the modules, as a part of the apparatus, may be executed in a computer system such as a set of computer-executable instructions.

### Embodiment 5

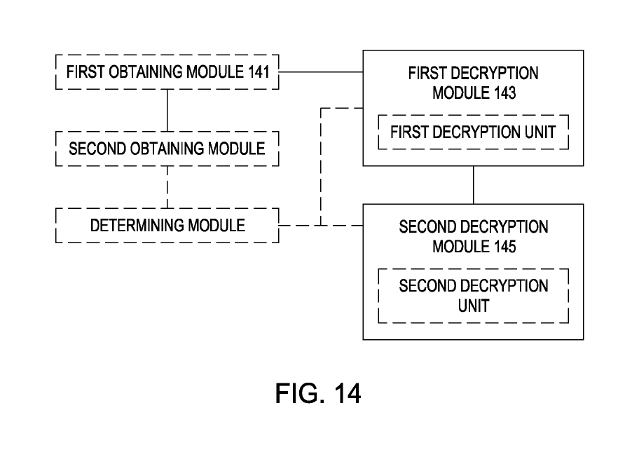

According to this embodiment of the present application, an embodiment of an apparatus for implementing the data decryption method in Embodiment 3 is further provided. FIG. 14 is a schematic diagram of a data decryption apparatus according to an embodiment of the present application. As shown in FIG. 14, the apparatus includes: a first obtaining module 141, a first decryption module 143, and a second decryption module 145.

The first obtaining module 141 is configured to obtain upload data uploaded by an encryption terminal to a blockchain.

The first decryption module 143 is configured to decrypt an encrypted block key in the upload data with a pre-stored private key of a decryption terminal to obtain a block key generated by the encryption terminal.

The second decryption module 145 is configured to decrypt encrypted data in the upload data with the block key to obtain to-be-uploaded data encrypted by the encryption terminal.

It should be noted that the first obtaining module 141, the first decryption module 143, and the second decryption module 145 correspond to steps S902 to S906 in Embodiment 3. Examples implemented by the above module and corresponding steps are the same as application scenarios, but are not limited to content disclosed in the above Embodiment 3. It should be noted that the modules, as a part of the apparatus, may be executed in a computer system such as a set of computer-executable instructions.

Therefore, in the above embodiment of the present application, the first obtaining module 141 obtains encrypted data uploaded by an encryption terminal to a blockchain and obtained by encrypting raw data with a block key, and encrypted block key obtained by encrypting the block key with a public key for a user allowed to view the raw data, the first decryption module 143 uses a private key of a decryption terminal to decrypt a decrypted block key to obtain the block key used for encrypting the raw data by the encryption terminal, and the second decryption module 145 uses the block key to decrypt the obtained encrypted data to obtain the raw data uploaded by the encryption terminal.

The solutions provided in the above embodiment of the present application achieves an objective of viewing data uploaded to the blockchain only by allowed application parties or supervision parties, so as to implement the technical effect of protecting user data privacy.

Accordingly, the solutions of the above embodiment provided by the present application solve the technical problems of excessive workload and complicated operation caused by implementing data access permission control in the blockchain.

In an alternative embodiment, as shown in FIG. 14, the above apparatus further includes: a second obtaining module, configured to obtain a data signature in the upload data before decrypting the encrypted block key in the upload data with the pre-stored private key for the decryption terminal; and a determining module, configured to determine whether the data signature is a signature of the upload data uploaded by the encryption terminal; decrypt the encrypted block key in the upload data if a determining result is yes; and suspend processing of the upload data if the determining result is no.

It should be noted that the second obtaining unit and the determining unit correspond to steps S102 to S108 in Embodiment 3. Examples implemented by the above module and corresponding steps are the same as application scenarios, but are not limited to content disclosed in the above Embodiment 3. It should be noted that the modules, as a part of the apparatus, may be executed in a computer system such as a set of computer-executable instructions.

In an alternative embodiment, as shown in FIG. 14, the first decryption module includes: a first decryption unit, configured to decrypt the encrypted block key based on the private key through an asymmetric cryptographic algorithm to obtain the block key generated by the encryption terminal.

It should be noted that the first decryption unit corresponds to step S112 in Embodiment 3. Examples implemented by the above module and corresponding steps are the same as application scenarios, but are not limited to content disclosed in the above Embodiment 3. It should be noted that the modules, as a part of the apparatus, may be executed in a computer system such as a set of computer-executable instructions.

In an alternative embodiment, as shown in FIG. 14, the second decryption module includes: a second decryption unit, configured to decrypt the encrypted data based on the block key through a symmetric cryptographic algorithm to obtain the to-be-uploaded data encrypted by the encryption terminal.

It should be noted that the second decryption unit corresponds to step S122 in Embodiment 3. Examples implemented by the above module and corresponding steps are the same as application scenarios, but are not limited to content disclosed in the above Embodiment 3. It should be noted that the modules, as a part of the apparatus, may be executed in a computer system such as a set of computer-executable instructions.

### Embodiment 6

An embodiment of the present application may provide a computer terminal, which may be any computer terminal device in a group of computer terminals. Optionally, in this embodiment, the above computer terminal may also be replaced with a terminal device such as a mobile terminal.

Optionally, in this embodiment, the above computer terminal may be located in at least one access device of a plurality of network devices in a computer network.

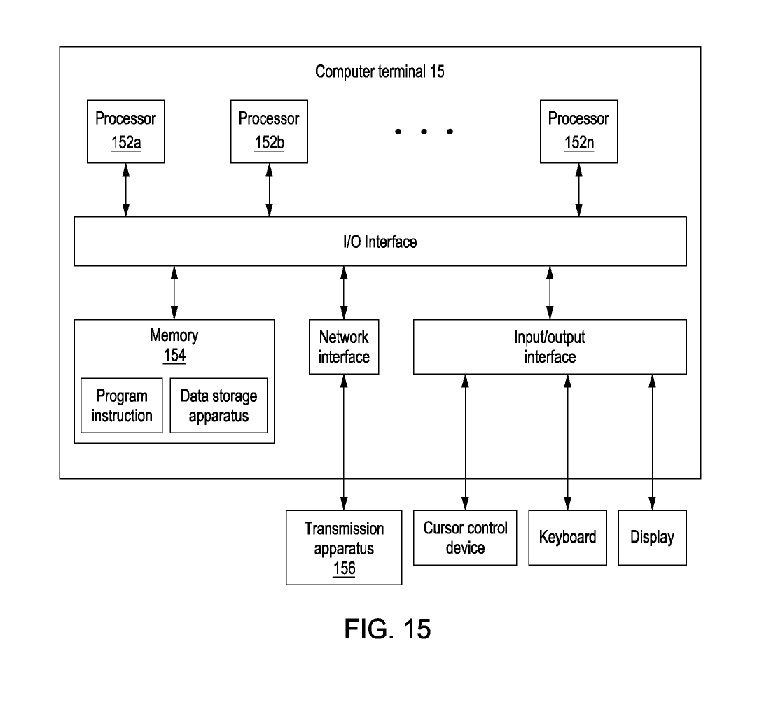

FIG. 15 is a hardware structural block diagram of a computer terminal. As shown in FIG. 15, the computer terminal 15 may include one or more (shown as 152a, 152b, . . . , 152n in the drawing) processors 152 (the processor 152 may include but is not limited to a processing apparatus of a microprocessor MCU or a programmable logic device FPGA), a memory 154 for storing data, and a transmission apparatus 156 used for a function of communication. In addition, it may also include: a display, an input/output interface (I/O interface), a universal serial bus (USB) port (which may be included as one of the ports of the I/O interface), a network interface, and a power source and/or a camera. A person of ordinary skill in the art can understand that the structure shown in FIG. 15 is only an illustration, which does not limit the structure of the above electronic apparatus. For example, the computer terminal 15 may also include more or fewer components than those shown in FIG. 15, or have a different configuration from that shown in FIG. 15.

It should be noted that the one or more processors 152 and/or other data processing circuits described above may generally be referred to herein as “data processing circuits.” The data processing circuit may be embodied in whole or in part as software, hardware, firmware, or any other combination. In addition, the data processing circuit may be a single, independent processing module, or may be combined in whole or in part into any of the other elements in the computer terminal 15. As involved in this embodiment of the present application, the data processing circuit is controlled by a processor (for example, an option of a variable resistance termination path connected to an interface).

The processor 152 may invoke the information and the application program stored in the memory by a transmission apparatus to perform the following steps: obtaining a selected path in a map; generating a dynamic image of the path according to the road condition information of the selected path, where the dynamic image of the path is an image dynamically moving from a start position to a destination of the path; and the dynamic image of the path is displayed in the map.

The memory 154 may be used to store software programs and modules of application software, such as a program instruction/data storage device corresponding to the data encryption method in Embodiment 2 or the data decryption method in Embodiment 3 of the present application. The processor 152 executes various functional applications and data processing by executing software programs and modules stored in the memory 154, that is, implements the data encryption method or the data decryption method of the above application program. The memory 154 may include a high speed random access memory, and may also include a non-volatile memory such as one or more magnetic storage devices, flash memory, or other non-volatile solid-state memory. In some examples, the memory 154 may further include a memory remotely disposed with respect to the processor 152. The remote memory may be connected to the computer terminal 15 via a network. Examples of such network include, but are not limited to, the Internet, intranet, local area networks, mobile communications networks, and combinations thereof.

The transmission apparatus 156 is used to receive or send data via a network. The above specific example of the network may include a wireless network provided by a communication provider of the computer terminal 15. In one example, the transmission apparatus 156 includes a network interface controller (NIC) that can be connected to other network devices through a base station so that it can communicate with the Internet. In one example, the transmission apparatus 156 may be a radio frequency (RF) module for wirelessly communicating with the Internet.

A display may be, for example, a touch screen liquid crystal display (LCD), which may enable a user to interact with the user interface of the computer terminal 15.

It should be noted here that in some alternative embodiments, the computer terminal 15 shown in FIG. 15 described above may include hardware elements (including circuits), software elements (including computer code stored on a computer-readable medium), or a combination of both hardware and software components. It should be noted that FIG. 15 is merely one example of a specific concrete example, and is intended to show the types of components that may exist in the above computer terminal 15.

As an optional implementation, in this embodiment, the computer terminal 15 may execute a program code with the following steps in the data encryption method of the application program: generating a block key and encrypting to-be-uploaded data based on the block key to obtain encrypted data; encrypting the block key based on a public key of a preset target object to obtain an encrypted block key corresponding to the preset target object; and generating upload data according to the encrypted data and the encrypted block key and uploading the upload data to a blockchain.

The processor may invoke information and application programs stored in the memory through the transmission apparatus to execute the following steps: generating a block key and encrypting to-be-uploaded data based on the block key to obtain encrypted data; encrypting the block key based on a public key of a preset target object to obtain an encrypted block key corresponding to the preset target object; and generating upload data according to the encrypted data and the encrypted block key and uploading the upload data to a blockchain.

Optionally, the processor may also execute a program code with the following step: encrypting the to-be-uploaded data based on the block key through a symmetric cryptographic algorithm to obtain the encrypted data, where the symmetric cryptographic algorithm is configured to be used by an encryption terminal and a decryption terminal to encrypt and decrypt with the same key.

Optionally, the processor may also execute a program code with the following steps: extracting the public key for the preset target object through a pre-obtained digital certificate; and encrypting the block key based on the public key through an asymmetric cryptographic algorithm to obtain the encrypted block key, where the asymmetric cryptographic algorithm is configured to be used by the encryption terminal to encrypt to-be-encrypted data with the public key of the decryption terminal, and by the decryption terminal to decrypt the to-be-encrypted data with a private key of the decryption terminal.

Optionally, the processor may also execute a program code with the following step: obtaining, if a number of the preset target object is in plurality, respective public keys for the plurality of target objects; and encrypting the block key based on the respective public keys of the plurality of target objects through the asymmetric cryptographic algorithm to obtain a plurality of encrypted block keys.

Optionally, the processor may also execute a program code with the following step: signing the encrypted data and the encrypted block key based on the pre-obtained private key of the encryption terminal to obtain a data signature; and generating upload data according to the encrypted data, the encrypted block key, and the data signature, where the data signature is configured to authenticate at the decryption terminal whether the upload data is data uploaded by the encryption terminal.

As another alternative embodiment, in this embodiment, the computer terminal 15 may execute a program code with the following steps of the data decryption method of an application program: obtaining upload data uploaded by an encryption terminal to a blockchain; decrypting an encrypted block key in the upload data with a pre-stored private key of a decryption terminal to obtain a block key generated by the encryption terminal; and decrypting encrypted data in the upload data with the block key to obtain to-be-uploaded data encrypted by the encryption terminal.

Optionally, the processor may also execute a program code with the following step: obtaining a data signature in the upload data; determining whether the data signature is a signature of the upload data uploaded by the encryption terminal; decrypting the encrypted block key in the upload data if a determining result is yes; and suspending processing of the upload data if the determining result is no.

Optionally, the processor may also execute a program code with the following step: decrypting the encrypted block key based on the private key through an asymmetric cryptographic algorithm to obtain the block key generated by the encryption terminal.

Optionally, the asymmetric cryptographic algorithm is configured to be used by the encryption terminal to encrypt to-be-encrypted data with the public key of the decryption terminal, and by the decryption terminal to decrypt the to-be-encrypted data with the private key of the decryption terminal.

Optionally, the processor may also execute a program code with the following step: decrypting the encrypted data based on the block key through a symmetric cryptographic algorithm to obtain the to-be-uploaded data encrypted by the encryption terminal.

Optionally, the symmetric cryptographic algorithm is configured to be used by the encryption terminal and the decryption terminal to encrypt and decrypt with the same key.

### Embodiment 7

An embodiment of the present application further provides a storage medium. Optionally, in this embodiment, the storage medium may be configured to store program codes executed by the data encryption method provided in Embodiment 2.

Optionally, in this embodiment, the storage medium may be located in any computer terminal in a group of computer terminals in a computer network, or located in any mobile terminal in a group of mobile terminals.

Optionally, in this embodiment, the storage medium is set to store program code used for executing the following steps: generating a block key and encrypting to-be-uploaded data based on the block key to obtain encrypted data; encrypting the block key based on a public key of a preset target object to obtain an encrypted block key corresponding to the preset target object; and generating upload data based on the encrypted data and the encrypted block key and uploading the upload data to a blockchain.

Optionally, in this embodiment, the storage medium is set to store program code used for executing the following step: encrypting the to-be-uploaded data based on the block key through a symmetric cryptographic algorithm to obtain the encrypted data, where the symmetric cryptographic algorithm is configured to be used by an encryption terminal and a decryption terminal to encrypt and decrypt with the same key.

Optionally, in this embodiment, the storage medium is set to store program code used for executing the following steps: extracting the public key for the preset target object through a pre-obtained digital certificate; and encrypting the block key based on the public key through an asymmetric cryptographic algorithm to obtain the encrypted block key, wherein the asymmetric cryptographic algorithm is configured to be used by the encryption terminal to encrypt to-be-encrypted data with the public key of the decryption terminal, and by the decryption terminal to decrypt the to-be-encrypted data with a private key of the decryption terminal.

Optionally, in this embodiment, the storage medium is set to store program code used for executing the following steps: obtaining, if a number of the preset target object is in plurality, respective public keys of the plurality of target objects; and encrypting the block key based on the respective public keys of the plurality of target objects through the asymmetric cryptographic algorithm to obtain a plurality of encrypted block keys.

Optionally, in this embodiment, the storage medium is set to store program code used for executing the following steps: signing the encrypted data and the encrypted block key based on the pre-obtained private key of the encryption terminal to obtain a data signature; and generating the upload data based on the encrypted data, the encrypted block key, and the data signature, where the data signature is configured to authenticate at the decryption terminal whether the upload data is data uploaded by the encryption terminal.

### Embodiment 8

An embodiment of the present application further provides a storage medium. Optionally, in this embodiment, the storage medium may be used to store program code executed by the data decryption method provided in Embodiment 3.

Optionally, in this embodiment, the storage medium may be located in any computer terminal in a group of computer terminals in a computer network, or located in any mobile terminal in a group of mobile terminals.

Optionally, in this embodiment, the storage medium is set to store program code used for executing the following steps: obtaining upload data uploaded by an encryption terminal to a blockchain; decrypting an encrypted block key in the upload data with a pre-stored private key of a decryption terminal to obtain a block key generated by the encryption terminal; and decrypting encrypted data in the upload data with the block key to obtain to-be-uploaded data encrypted by the encryption terminal.

Optionally, in this embodiment, the storage medium is set to store program code used for executing the following steps: obtaining a data signature in the upload data; determining whether the data signature is a signature of the upload data uploaded by the encryption terminal; decrypting the encrypted block key in the upload data if a determining result is yes; and suspending processing of the upload data if the determining result is no.

Optionally, in this embodiment, the storage medium is set to store program code used for executing the following steps: decrypting the encrypted block key based on the private key through an asymmetric cryptographic algorithm to obtain the block key generated by the encryption terminal.

Optionally, in this embodiment, the asymmetric cryptographic algorithm is configured to be used by the encryption terminal to encrypt to-be-encrypted data with the public key of the decryption terminal, and by the decryption terminal to decrypt the to-be-encrypted data with the private key of the decryption terminal.

Optionally, in this embodiment, the storage medium is set to store program code used for executing the following step: decrypting the encrypted data based on the block key through a symmetric cryptographic algorithm to obtain the to-be-uploaded data encrypted by the encryption terminal.

Optionally, in this embodiment, the symmetric cryptographic algorithm is configured be used by the encryption terminal and the decryption terminal to encrypt and decrypt with the same key.

### Embodiment 9

According to another aspect of embodiments of the present invention, a data processing method is further provided, including: obtaining encrypted data, wherein keys used for generating the encrypted data includes a block key; obtaining encrypted block key, wherein keys for encrypting the block key include a first public key; obtaining signature data, wherein keys used for signing includes a second private key; and sending the encrypted data, the encrypted block key, and the signature data to a server.

### Embodiment 10

According to another aspect of embodiments of the present invention, a data processing method is further provided, including: obtaining encrypted data, an encrypted block key, and signature data from a client; authenticating the signature data with a second public key; decrypting the encrypted block key with a first private key to obtain a block key; and decrypting the encrypted data with the block key to obtain upload data.

The sequence numbers of the foregoing embodiments of the present invention are merely for description and do not indicate advantages or disadvantages of the embodiments.

In the foregoing embodiments of the present invention, the description of each embodiment has its own emphasis. For a part not described in detail in one embodiment, reference may be made to relevant description of other embodiments.

In the several embodiments provided in the present application, it should be understood that the disclosed technical content may be implemented in other ways. The apparatus embodiments described above are merely illustrative, for example, the division of the units may be a division of logical function, and there may be other ways of division in actual implementations, for example, a plurality of units or components may be combined or may be integrated into another system; or, some features can be ignored or not implemented. In addition, the illustrated or discussed mutual coupling or direct coupling or communication connection may be indirect coupling or communication connection through some interfaces, units or modules, and may be electrical or in other forms.

The units described as separate parts may or may not be physically separated, and the parts displayed as units may or may not be physical units, that is, may be located in one place, or may be distributed on a plurality of units. Some or all of the units may be selected according to actual needs to achieve the purpose of the solution of this embodiment.

In addition, each functional unit in each embodiment of the present invention may be integrated in one processing unit, or each unit may exist physically independently, or two or more units may be integrated in one unit. The above integrated unit can be implemented either in hardware or in software functional units.

The integrated unit, when implemented in the form of a software functional unit and sold or used as a stand-alone product, may be stored in a computer-readable storage medium. Based on such understanding, the technical solution of the present invention can in essence, or in part contributing to the prior art or all or part of the technical solution may, be embodied in the form of a software product; the software product is stored in a storage medium, including certain instructions for enabling a computer device (which may be a personal computer, a server, a network device, etc.) to perform all or part of the steps of the methods described in the various embodiments of the present invention. The foregoing storage medium includes: an USB flash disk, a read-only memory (ROM), a random access memory (RAM), a mobile hard disk drive, a magnetic disk, an optical disk, or any other medium that may store program codes.

The above descriptions are only preferred embodiments of the present invention, and it should be noted that a person of ordinary skill in the art can also make several improvements and modifications without deviating from the principle of the present invention. These improvements and modifications may also be considered as falling within the scope of the present invention.

1. A data encryption method, comprising:
generating a block key and encrypting to-be-uploaded data based on the block key to obtain encrypted data;
encrypting the block key based on a public key of a preset target object to obtain an encrypted block key corresponding to the preset target object; and
generating upload data based on the encrypted data and the encrypted block key and uploading the upload data to a blockchain.

2. The method according to claim 1, wherein the encrypting to-be-uploaded data based on the block key to obtain encrypted data comprises:
encrypting the to-be-uploaded data based on the block key through a symmetric cryptographic algorithm to obtain the encrypted data, wherein the symmetric cryptographic algorithm is configured to be used by an encryption terminal and a decryption terminal to encrypt and decrypt with the same key.

3. The method according to claim 2, wherein the encrypting the block key based on a public key of a preset target object to obtain an encrypted block key corresponding to the preset target object comprises:
extracting the public key of the preset target object through a pre-obtained digital certificate; and
encrypting the block key based on the public key through an asymmetric cryptographic algorithm to obtain the encrypted block key, wherein the asymmetric cryptographic algorithm is configured to be used by the encryption terminal to encrypt to-be-encrypted data with a public key of the decryption terminal, and by the decryption terminal to decrypt the encrypted to-be-encrypted data with a private key of the decryption terminal.

4. The method according to claim 3, wherein the encrypting the block key based on the public key through the asymmetric cryptographic algorithm to obtain the encrypted block key comprises:
obtaining, if a number of the preset target object is in plurality, respective public keys of the plurality of target objects; and
encrypting the block key based on the respective public keys of the plurality of target objects through the asymmetric cryptographic algorithm to obtain a plurality of encrypted block keys.

5. The method according to claim 1, wherein the generating upload data based on the encrypted data and the encrypted block key comprises:
signing the encrypted data and the encrypted block key based on a pre-obtained private key of the encryption terminal to obtain a data signature; and
generating the upload data based on the encrypted data, the encrypted block key, and the data signature, wherein the data signature is configured to authenticate at the decryption terminal whether the upload data is data uploaded by the encryption terminal.

6. The method according to claim 1, wherein before the encrypting to-be-uploaded data based on the block key to obtain encrypted data, the method further comprises:
receiving a request to upload information to a blockchain, wherein the request to upload information to a blockchain comprises the to-be-uploaded data;
inspecting, according to a preset condition, whether the to-be-uploaded data is correct; and
encrypting the to-be-uploaded data based on the block key if an inspection result is correct.

7. The method according to claim 6, wherein the encrypting to-be-uploaded data based on the block key to obtain encrypted data comprises:
encrypting digest data in the to-be-uploaded data with the block key to obtain the encrypted data.

8. A data decryption method, comprising:
obtaining upload data uploaded by an encryption terminal to a blockchain;
decrypting an encrypted block key in the upload data with a pre-stored private key of a decryption terminal to obtain a block key generated by the encryption terminal; and
decrypting encrypted data in the upload data with the block key to obtain to-be-uploaded data encrypted by the encryption terminal.

9. The method according to claim 8, wherein before the decrypting an encrypted block key in the upload data with a pre-stored private key of a decryption terminal, the method further comprises:
obtaining a data signature in the upload data;
determining whether the data signature is a signature of the upload data uploaded by the encryption terminal;
decrypting the encrypted block key in the upload data if a determining result is positive; and
suspending processing of the upload data if the determining result is negative.

10. The method according to claim 8, wherein the decrypting an encrypted block key in the upload data with a pre-stored private key of a decryption terminal to obtain a block key generated by the encryption terminal comprises:
decrypting the encrypted block key based on the private key through an asymmetric cryptographic algorithm to obtain the block key generated by the encryption terminal.

11. The method according to claim 10, wherein the asymmetric cryptographic algorithm is configured to be used by the encryption terminal to encrypt to-be-encrypted data with a public key of the decryption terminal, and by the decryption terminal to decrypt the to-be-encrypted data with a private key of the decryption terminal.

12. The method according to claim 8, wherein the decrypting encrypted data in the upload data with the block key to obtain to-be-uploaded data encrypted by the encryption terminal comprises:
decrypting the encrypted data based on the block key through a symmetric cryptographic algorithm to obtain the to-be-uploaded data encrypted by the encryption terminal.

13. The method according to claim 12, wherein the symmetric cryptographic algorithm is configured to be used by the encryption terminal and the decryption terminal to encrypt and decrypt with the same key.

14. The method according to claim 8, wherein before the obtaining upload data uploaded by an encryption terminal to a blockchain, the method further comprises:
receiving a data service request;
returning user data service information and requirement information according to the data service request;
receiving user information returned based on the user data service information and requirement information and authenticating the user information;
sending a user data request message to the encryption terminal if an authentication result is that the user information is incomplete; and
receiving the user data sent by the encryption terminal.

15. The method according to claim 14, wherein the obtaining upload data uploaded by an encryption terminal to a blockchain comprises:
obtaining digest data in the upload data of the blockchain.

16. The method according to claim 15, wherein after the obtaining to-be-uploaded data encrypted by the encryption terminal, the method further comprises:
authenticating the digest data and the to-be-uploaded data; and
providing corresponding services after successful authentication of the digest data and the to-be-uploaded data according to a preset condition.

17. An encryption apparatus comprising:
a processor for encrypting data by generating a block key to encrypt to-be-uploaded data based on the block key, encrypting the block key based on a public key of a preset target object to obtain an encrypted block key corresponding to the preset target object and generating upload data based on the encrypted data and the encrypted block key;
a storage medium coupled to the processor for storing the block key, the encrypted data, and upload data; and
an output interface coupled to the storage medium that uploads the upload data to a block chain.

18. A data encryption device comprising:
a processor that obtains upload data uploaded by an encryption terminal to a blockchain, decrypts an encrypted block key in the upload data with a pre-stored private key of decryption terminal to obtain a block key generated by the encryption terminal, and decrypts encrypted data in the upload data with the block key to obtain to-be-uploaded data encrypted by the encryption terminal; and
a storage medium coupled to the processor that stores the upload data and encrypted block key.
